(19) United States
(12) Patent Application Publication
(10) Pub. No.: US 2022/0166511 A1
(43) Pub. Date: May 26, 2022

(54) Driver Circuit for One or Several Optical Transmitting Components, Receiver Circuit for One or Several Optical Receiving Components for Optical-Wireless Communication and Method

(71) Applicant: Fraunhofer-Gesellschaft zur Foerderung der angewandten Forschung e.V., Munich (DE)

(72) Inventors: René KIRRBACH, Dresden (DE); Benjamin JAKOB, Dresden (DE)

(21) Appl. No.: 17/669,158

(22) Filed: Feb. 10, 2022

Related U.S. Application Data
(63) Continuation of application No. PCT/EP2020/072867, filed on Aug. 14, 2020.

(30) Foreign Application Priority Data
Aug. 14, 2019 (DE) 10 2019 212 225.6

(51) Int. Cl. H04B 10/114; H04B 10/116

(52) U.S. Cl. CPC H04B 10/1143; H04B 10/116

(57) ABSTRACT

A driver circuit for one or several optical transmitting components including a controlled current source with a control circuit. The control circuit is configured such that a transfer characteristic of the driver circuit includes a maximum at a predetermined frequency. A receiver circuit for one or several optical receiving components for optical-wireless communication includes a compensation circuit configured to at least partly compensate an effect of a capacitance of the one or several optical receiving components, wherein the compensation circuit is coupled to at least one of the one or several optical receiving components with two terminals. The receiver circuit includes an amplifier circuit configured to obtain an amplified output signal based on a current provided by the one or several optical receiving components. The compensation circuit is configured to generate a maximum in a frequency response to at least partly compensate a low-pass behavior of the amplifier circuit.

### CROSS-REFERENCE TO RELATED APPLICATIONS

This application is a continuation of copending International Application No. PCT/EP2020/072867, filed Aug. 14, 2020, which is incorporated herein by reference in its entirety, and additionally claims priority from German Application No. 10 2019 212 225.6, filed Aug. 14, 2019, which is also incorporated herein by reference in its entirety.

Embodiments according to the invention relate to a driver circuit for one or several optical transmitting components, a receiver circuit for one or several optical receiving components for optical-wireless communication and a method.

### BACKGROUND OF THE INVENTION

Optical-wireless communication can solve the interference problem by spatially well-defined communication links as the field of view of the transceivers is strictly limited, normally in a cone shape. There are two conventional approaches to obtain data rates (baud rates) in the range of larger ≥100 Mbit/s at the transmitter, however, both have individual disadvantages: Conventional light diodes (LEDs) are combined with a complex modulation method such as OFDM (orthogonal frequency-division multiplexing). However, this results in significant system complexity and high power consumption. These systems can be optimized by using a simple modulation such as PAM (pulse amplitude modulation). However, this reduces the link budget (i.e. also the range) of the communication link. OOK (on-off keying) can classically not be used as the modulation bandwidth of the LED is not sufficient. Here, the modulation bandwidth relates to the transfer function of the LED, i.e. the optical output signal divided by the forward current through the LED.

An emitter having sufficient modulation bandwidth, such as RCLED, laser, laser diode, micro LED is used. These devices are normally very cost-intensive or have a low optical output power, which again limits the link budget (i.e. also the range). Above that, eye safety limits have to be observed.

To obtain data rates in the range of ˜ 100 Mbit/s at the optical-wireless receiver, the conventional approach is the selection of a photodiode with respectively low barrier layer capacitance and a matching transimpedance amplifier (TIA). However, such photodiodes have a small active area, such that the same can only collect little power of the optical communication signal. The transimpedance amplification of the TIA has to be selected so low that the needed bandwidth is obtained. Both measures result in a limited link budget, i.e. a low bandwidth.

In the following, further conventional methods are presented.

Reference WO08089902A1 describes a system and a method for controlling one or several switchgears. DE102010015353A1 describes a portable height measuring and marking device. Reference DE202015004127U1 describes a modular sensor system platform for measurements, cleanings and calibrations in analytical, temperature and pressure measurement technology. In contrast, the invention described herein discloses a real-time optical-wireless data transmission path using, for example, LEDs. Reference EP1772112A2 describes a medical device for monitoring/diagnostics. In contrast, the invention described herein, according to one embodiment, is used in industrial applications. Reference WO10076028A1 describes a system and method for determining and monitoring volumetric flow rates. Reference EP2924400A1 describes means for detecting, classifying and weighing motor vehicles on roads in flowing traffic. Reference CN207683529U describes an unmanned control system for a 65T electric locomotive. Reference US2015208195A describes a method and apparatus for out-of-band location services. Reference U.S. Pat. No. 5,250,943A describes a GVT-NET-A global virtual time computing device for multistage networks. In contrast, the invention described herein is not fiber-bound. Reference US2002052185A describes a portable data acquisition network with telephone and voice messaging capability. Reference US2005235159A describes a wireless transmitter-receiver system for computer input devices. Reference US2012225639A describes a portable computer-based wireless payment apparatus and method. Reference US2012182143A describes a wireless relay module for remote monitoring systems with power and medical process monitoring functionality. Reference US2016142612A describes apparatuses, methods and systems for visual imaging devices. Reference US2014265359A describes an intelligent door lock system. Reference US2013278076A describes a telemetry system with wireless power receiver and monitoring devices. Reference CO6610233A describes an information system for traffic participants about the traffic situation. Reference EP2538500A1 describes coupling means for communication devices. In contrast, the invention described herein, according to an embodiment, comprises an optical-wireless connection. Reference US2019082521A [1] describes a driver device. In contrast, the invention described herein, according to an embodiment, comprises a fixed supply voltage for LEDs or light sources used. Further, according to the invention described herein, in contrast to [1], a control current for LEDs or light sources used may be substantially independent of the supply voltage. Further, according to an embodiment of the present invention, in contrast to [1], it is possible to operate in a non-linear range of an optical output power to the current input curve of the LEDs or other light source. According to an embodiment, ir LEDs (infrared LEDs) or single-chip (single component) LEDs (e.g., red) are used. Reference US2015098709A describes techniques for transmitting position information from luminaires. Reference U.S. Pat. No. 5,373,384A describes a semiconductor source with nonlinear compensation means within a predistortion circuit. Reference US2009079355A describes a digital driver device, method and system for solid phase illumination. Reference WO18138495A1 describes an optical-wireless communication system.

For the advancing automation of industry, reliable data communication is mandatory. In addition, machine-to-machine communication in particular places strict requirements on the real-time capability of the data links, i.e. transmission latencies that are as low as possible. For this reason, industrial Ethernet standards such as SERCOS III, ProfiNET, EtherNet/IP, VARANx, SafteyNET p, EtherCAT, Ethernet Powerlink, but also other industrial bus systems are gaining ground today. Data rates typically range from =10 Mbps, =100 Mbps (=125 Mbps baud rate) up to =1000 Mbps (=1250 Mbps baud rate), with 100 Mbps systems in particular being widely used today. Traditional wired communication links might not provide the needed mobility/flexibility, so wireless data links are increasingly needed. Radio-based wireless technologies are reaching their limits due to the strict real-time requirements. This results in particular from interferences between different communication channels or different communication standards.

### SUMMARY

According to an embodiment, a receiver circuit for one or several optical receiving components for optical-wireless communication may have: the one or the several optical receiving components and a compensation circuit that is configured to at least partly compensate an effect of a capacitance of the one optical receiving component or an effect of capacitances of the several optical receiving components, wherein the effect of the capacitance or the capacitances may have attenuating a photocurrent provided by the one or the several optical receiving components, wherein the compensation circuit is coupled to at least one of the one or several optical receiving components with two terminals, wherein the receiver circuit may have an amplifier circuit that is configured to obtain an amplified output signal based on the photocurrent provided by the one or several optical receiving components; wherein the compensation circuit is configured to generate a maximum in a frequency response to at least partly compensate a low-pass behavior of the amplifier circuit, wherein the frequency response represents a ratio between the photocurrent provided to the amplifier circuit and an optical input signal detected by the one or several optical receiving components; wherein the compensation circuit may have a transistor and a first impedance arrangement, wherein a first terminal of the one or the several optical receiving components is coupled to a control terminal of the transistor, wherein the first impedance arrangement or at least one component of the first impedance arrangement is connected between a first terminal of a controlled path of the transistor and a second terminal of the one or the several optical receiving components and wherein a second terminal of the controlled path of the transistor is coupled to a reference potential conductor.

According to another embodiment, a receiver circuit for one or several optical receiving components for optical-wireless communication may have: the one or the several optical receiving components and an amplifier circuit that is configured to obtain an amplified output signal based on a current provided by the one or several optical receiving components; wherein the amplifier circuit max have an operational amplifier; wherein a feedback path of the amplifier circuit may have a series connection of a coil component and an impedance arrangement, wherein the impedance arrangement may have at least one capacitor and/or one resistor; and wherein the coil component is configured to at least partly compensate a low-pass behavior of the amplifier circuit.

According to another embodiment, a method for receiving an optical signal by using one or several optical receiving components for optical-wireless communication, may have the steps of: at least partly compensating an effect of a capacitance of the one optical receiving components or an effect of capacitances of the several optical receiving components, wherein the effect of the capacitance or the capacitances may have attenuating a photocurrent provided by the one or the several optical receiving components, amplifying to obtain an amplified output signal based on the photocurrent provided by the one or several optical receiving components; wherein, during compensating, a maximum is generated in a frequency response to at least partly compensate a low-pass behavior of the amplifier circuit, wherein the frequency response represents a ratio between the photocurrent provided to the amplifier circuit and an optical input signal detected by the one or several optical receiving components; wherein compensating is performed by means of a transistor and a first impedance arrangement, wherein a first terminal of the one or the several optical receiving components is coupled to a control terminal of the transistor, wherein the first impedance arrangement or at least one component of the first impedance arrangement is connected between a first terminal of a controlled path of the transistor and a second terminal of the one or the several optical receiving components and wherein a second terminal of the controlled path of the transistor is coupled to a reference potential conductor.

An embodiment relates to a driver circuit, e.g. a control circuit for one or several optical transmitting components. According to an embodiment, the one or several optical transmitting components can comprise or represent a light emitting diode or a series connection of light emitting diodes. However, the usage of other illuminants, such as laser is possible. Here, the one or several optical transmitting components emit, e.g., visible light, infrared light and/or ultraviolet light. The driver circuit comprises a controlled current source with a control circuit and the control circuit or, e.g., the driver circuit is configured or dimensioned such that a transfer characteristic of the driver circuit has a maximum, such as a peak or overshoot at a predetermined frequency, such as a resonant frequency. The controlled current source is, e.g. a differential amplifier based or operational amplifier based current source. The current source is, for example, current controlled or voltage controlled. The transfer characteristic of the driver circuit represents, for example, a quotient between current provided to the one or several optical transmitting components and an input signal of the driver circuit. Further, the transfer characteristic of the driver circuit can be a voltage-current transfer characteristic.

This embodiment of the driver circuit is based on the finding that by an overshoot of the transfer characteristic of the driver circuit, a low-pass characteristic of the one or several optical transmitting components or the optoelectronic components in a transfer system can be at least partly compensated. Due to the fact that the maximum occurs at a predetermined frequency, an overall transfer characteristic of a transceiver comprising the driver circuit and the one or several optical transmitting components can be optimized in a range around this predetermined frequency. The overall transfer characteristic of the transceiver represents, for example, a quotient between an optical power of the one or several optical transmitting components and an input signal of the driver circuit. The overall transfer characteristic results, for example as a product of the transfer characteristic of the driver circuit and a current-to-optical output power characteristic (e.g. an optical transfer characteristic) of the one or several optical transmitting components. This allows, among others, that the transceiver can also be operated at frequencies e.g. higher than a cutoff frequency of the one or several optical transmitting components with high range and without low-pass behavior (which would result in symbol crosstalk). The control circuit is configured, e.g., such that the predetermined frequency is adapted, e.g. to the one or several optical transmitting components, whereby the driver circuit is configured to control the one or several optical transmitting components in an optimized manner. This allows, among others, an improvement of a modulation bandwidth of the optical transmitting components or the entire optical-wireless transmitter. This provides an improved optical-wireless real-time data transmission with reduced production costs as the optimized driver circuit enables the usage of simple cost-effective optical transmitting components.

Thus, it has to be stated that the driver circuit allows an improved control of the one or several optical transmitting components. In particular, e.g., for high-frequency signals.

According to an embodiment, the control circuit is configured such that the maximum of the transfer characteristic of the driver circuit is at a frequency that deviates by at most 80% or at most 40% or at most 20% from a cutoff frequency of the one or several optical transmitting components. Here and in the following, the cutoff frequency of the one or several optical transmitting components can mean, e.g., a −10 dB cutoff frequency, a −5 dB cutoff frequency, a −3 dB cutoff frequency, a −1 dB cutoff frequency or a cutoff frequency where an optical nominal power of the one or several optical transmitting components decreases to 80% nominal power or less, to 70% nominal power or less, to 60% nominal power or less, to 55% nominal power or less or to 50% nominal power or less. Due to the fact that the maximum of the transfer characteristic is within a tolerance range around the cutoff frequency, allows the compensation of a low-pass characteristic of the one or several optical transmitting components by means of the driver circuit.

According to an embodiment, the control circuit is configured such that the maximum of the transfer characteristic of the driver circuit is at a frequency that is greater than the cutoff frequency of the one or several optical transmitting components. Here, an increase of the transfer characteristic of the driver circuit up to the maximum can counteract a decrease of an optical transfer characteristic representing, e.g., a quotient between an optical power of the one or several optical transmitting components and a current provided to the one or several optical transmitting components. Here, the predetermined frequency where the maximum occurs can be predetermined by the control circuit such that the increase of the transfer characteristic of the driver circuit to the maximum completely or at least partly compensates the decrease of the optical transfer characteristic.

According to an embodiment, the control circuit is configured such that the maximum of the transfer characteristic of the driver circuit is at a frequency that is less than 120% or 150% or 200% of the cutoff frequency of the one or several optical transmitting components. This ensures that the compensation of the low-pass characteristic of the one or several optical transmitting components already starts directly at the start of the low-pass characteristic or shortly after. This allows a compensation up to higher frequencies that is as uniform as possible. Thereby, local minima in the overall transfer characteristic of a transceiver can be minimized or prevented, which also optimizes optical-wireless transfer of high-frequency signals in a range around the cutoff frequency.

According to an embodiment, the control circuit is configured such that the transfer characteristic of the driver circuit comprises, at a cutoff frequency of the one or several optical transmitting components, an elevation compared to a value of the transfer characteristic at a lower frequency that is, e.g., lower than the cutoff frequency. The transfer characteristic runs, e.g., constant or with little variations up to a starting frequency lower than the cutoff frequency. At the starting frequency, e.g., an increase of the transfer characteristic starts and results in an elevation of the cutoff frequency. After the cutoff frequency, e.g., a further increase of the transfer characteristic results in the maximum of the predetermined frequency. Here and in the following, the elevation of the cutoff frequency can mean, e.g., an elevation by at least 1 dB or by at least 3 dB or by at least 5 dB or by at least 10 dB compared to the value of the transfer characteristic at the lower frequency or compared to a value in the constant or only slightly varying range of the transfer function. Since a decrease of a nominal power of the one or several optical transmitting components can already occur at the cutoff frequency, by the elevation of the transfer characteristic of the driver circuit at the cutoff frequency, a low-pass behavior of the one or several optical transmitting components can already be at least partly compensated.

According to an embodiment, the control circuit is configured such that the transfer characteristic of the driver circuit comprises an elevation, for example by at least 1 dB or by at least 3 dB or by at least 5 dB or by at least 10 dB compared to a value of the transfer characteristic at a lower frequency that starts at a first frequency that is lower than a cutoff frequency of the one or several optical transmitting components and that extends up to a second frequency that is greater than the cutoff frequency of the one or several optical transmitting components. The value of the transfer characteristic at the lower frequency represents, e.g. a reference value. The lower frequency is, e.g., lower than the first frequency where the elevation starts. The lower frequency is, e.g., in a frequency range where the transfer characteristic of the driver circuit has an essentially flat course. Here and in the following, the start of the elevation of the first frequency corresponds, e.g., to a frequency where a value of the transfer characteristic reaches an elevation of at least 0.5 dB, of at least 1 dB, of at least 1.5 dB with respect to the value at the lower frequency. The elevation comprises, e.g., an increase of values of the transfer characteristic starting from the first frequency up to the maximum at the predetermined frequency and subsequently again a decrease of values of the transfer characteristic up to the second frequency. The second frequency corresponds, for example, to a cutoff frequency of the overall transfer characteristic of the transceiver. The cutoff frequency of the overall transfer characteristic is, e.g., a −2 dB cutoff frequency, a −3 dB cutoff frequency or a −4 dB cutoff frequency. Here, the prefix −x dB (x∈[2,3,4]) relates, for example, to a value of the overall transfer characteristic at a frequency that is lower than the cutoff frequency, such as to a value in an essentially flat region of the overall transfer characteristic. The elevation caused by the circuit is terminated, e.g., at the second frequency. This enables a very exact compensation of a low-pass characteristic of the one or several optical transmitting components since a decrease of the optical transfer characteristic can already occur prior to the cutoff frequency, which can already be partly compensated by the elevation realized by the circuit. Thus, an optimized compensation of the low-pass characteristic of the one or several optical transmitting components between the first frequency and the second frequency is ensured.

According to an embodiment, the control circuit is configured such that the transfer characteristic of the driver circuit comprises an elevation, for example by at least 1 dB or by at least 3 dB or by at least 5 dB or by at least 10 dB, compared to a value of the transfer characteristic at a lower frequency, e.g. lower than the cutoff frequency, which starts at a frequency that is greater than the cutoff frequency of the one or several optical transmitting components and that extends up to a higher frequency. The frequency that is greater than the cutoff frequency corresponds, e.g., to a frequency where a value of the transfer characteristic comprises, e.g., for a first time, an elevation of at least 0.5 dB, of at least 1 dB or of at least 1.5 dB with respect to the value at the lower frequency and/or the higher frequency corresponds, e.g., to a frequency where a value of the transfer characteristic, for example a further time comprises an elevation of at least 0.5 dB, of at least 1 dB or of at least 1.5 dB with respect to the value at the lower frequency. Due to the fact that the elevation starts at a frequency that is greater than the cutoff frequency of the one or several optical transmitting components, for example, a local minimum of the overall transfer characteristic or an overall transfer function results. The local minimum is, for example, in a range of the cutoff frequency of the one or several optical transmitting components. This allows shifting of a cutoff frequency of the overall transfer characteristic to high frequencies, wherein it is accepted that only partial compensation is realized in a range around the local minimum. Thus, the modulation bandwidth of the one or several optical transmitting components is increased further.

According to an embodiment, a maximum elevation of the transfer characteristic of the driver circuit is between 2 dB and 20 dB or between 2 dB and 12 dB or between 2 dB and 6 dB with regard to a value of the transfer characteristic at a lower frequency that is lower than a frequency where the elevation starts. The lowest frequency is, e.g., a frequency resulting from line coding, i.e. the lower-frequency spectral components that are still used for data transmission (for example on-off keying): maximum number of subsequent ones or zeros). The maximum elevation of the transfer characteristic of the driver circuit corresponds, for example, to the maximum of the transfer characteristic of the driver circuit. As already described above, the lower frequency can correspond to a frequency where the transfer characteristic of the driver circuit comprises an essentially flat course. The control circuit is, e.g., configured such that the maximum elevation of the driver circuit at least partly or completely compensates a decrease of the optical transfer characteristic of the one or several optical transmitting components at the predetermined frequency.

According to an embodiment, the controlled current source comprises a differential amplifier, a transistor and a feedback network. An output of the differential amplifier is coupled to a control terminal, such as a gate terminal or a base terminal, of the transistor and the transistor is configured to adjust a current for the one several optical transmitting components, and the current for the one or several transmitting components flows, e.g. through a controlled path of the transistor. The differential amplifier represents, e.g. an operational amplifier. The current for the one or several optical transmitting components is adjusted, e.g. in dependence on the control signal applied to the control terminal. The feedback network is configured to feedback a feedback signal that is based on the current for the one or several optical transmitting components to a feedback input of the differential amplifier. Thereby, the control circuit is closed. The differential amplifier tries to regulate, e.g., the difference of its inputs to 0, i.e. it readjusts the current according to the input signal. Close to the resonant frequency of the circuit, this enables supplying the one or several optical transmitting components at high frequencies, i.e. higher than the cutoff frequency of the one or several optical transmitting components, with a higher current than at lower frequencies by means of the driver circuit, whereby, at the high frequencies, a reduction of an optical power of the one or several optical transmitting components can at least be partly prevented.

According to an embodiment, the controlled current source comprises a resistor that is connected between an output of the differential amplifier and a control terminal of the transistor.

According to an embodiment, the controlled current source comprises a capacitor that is connected between the output of the differential amplifier and the feedback input of the differential amplifier.

According to an embodiment, the controlled current source comprises an impedance arrangement that is configured to generate, based on a current flow through a controlled path of the transistor, a signal, such as a voltage signal that is fed back to the feedback input of the differential amplifier. The impedance arrangement is, e.g., part of the feedback network of the current source.

According to an embodiment, the impedance arrangement comprises a parallel connection of a resistor and a capacitor. The impedance arrangement is configured, e.g., to obtain a reduced feedback effect with increasing frequency.

According to an embodiment, the impedance arrangement is coupled between a terminal, such as a source terminal, of a controlled path of the transistor and a reference potential conductor, such as ground. The controlled path is, e.g. a source-drain path.

According to an embodiment, the controlled current source comprises a resistor that is coupled between the impedance arrangement and the feedback input of the differential amplifier.

According to an embodiment, the controlled current source comprises a coil that is connected into an output current path through which current provided to the one or several optical transmitting components flows. In other words, current provided to the one or several optical transmitting components flows through the output current path. The coil is connected, for example, between a terminal, such as a drain terminal of the controlled path of the transistor, and a transmitting component terminal of the controlled current source. Alternatively, the coil is connected in series to one of the one or several optical transmitting components. By the coil, the frequency response of the current flowing through the one or several optical transmitting components can be adjusted.

According to an embodiment, the resistor that is connected between the output of the differential amplifier and the control terminal of the transistor and/or the capacitor that is connected between the output of the differential amplifier and the feedback input of the differential amplifier and/or the impedance arrangement and/or the resistor that is coupled between the impedance arrangement and the feedback input of the differential amplifier and/or an inductive element is configured to achieve that the transfer characteristic of the driver circuit comprises a maximum at the predetermined frequency. The inductive element can be parasitic inductances, such as power inductances, or the coil that is connected into the output current path through which the current (214c) provided to the one or several optical transmitting components (220, 2211-221n) flows. The individual components cooperate advantageously within the current source in order to be able to realize the maximum of the transfer characteristic of the driver circuit and to thereby compensate a low-pass behavior of the one or several optical transmitting components.

According to an embodiment, the driver circuit is configured to control the one or several optical transmitting components, such that optical-wireless communication with a high bandwidth of e.g. at least 20 Mbit/s or at least 50 Mbit/s or at least 100 Mbit/s or at least 200 Mbit/s or at least 300 Mbit/s is realized.

According to an embodiment, the driver circuit is configured to at least partly compensate a low-pass characteristic of the one or several optical transmitting components and/or of optoelectronic components in a transfer system with the control circuit.

One embodiment relates to a receiver circuit for one or several optical receiving components for optical-wireless communication. The receiver circuit comprises a compensation circuit that is configured to at least partly compensate an effect of a capacitance of the one or several optical receiving components. Here, the compensation circuit is coupled to at least one of the one or several optical receiving components with two terminals. The compensation circuit is connected in parallel, e.g., to the one or several optical receiving components. Additionally, the receiver circuit comprises an amplifier circuit that is configured to obtain an amplified output signal, such as an amplified voltage signal or an amplified current signal, based on a current provided by the one or several optical receiving components. The amplifier circuit comprises, for example, a transimpedance amplifier. The compensation circuit is configured to generate a maximum in a frequency response to at least partly compensate a low-pass behavior of the amplifier circuit. The frequency response represents, e.g., a ratio between a current provided to the amplifier circuit and an optical input signal detected by the one or several optical receiving components. The low-pass behavior that at least partly compensates the compensation circuit typically results, e.g., from a cooperation of the optical receiving components provided with a capacitance and the transimpedance amplifier.

This embodiment of the receiver circuit is based on the finding that a greater active area of the one or several optical receiving components can be realized by the compensation circuit, since the effect of the capacitances of the one or several optical receiving components can at least be partly compensated. Thereby, the receiver circuit can collect a high power of an optical communication signal. For at least partly compensating the effect of the capacitance of the one or several optical receiving components, for example, a recharge of the capacitance is accelerated with the compensation circuit or a variation of a voltage across the one or several optical receiving components is reduced. Additionally, the receiver circuit is based on the finding that the compensation circuit can realize a high transimpedance amplification at high bandwidth by means of the amplifier circuit, since the low-pass behavior of the amplifier circuit can at least be partly compensated. Due to the fact that the compensation circuit enables both collecting high power of an optical communication signal by means of the receiver circuit as well as obtaining high transimpedance amplification, optical-wireless communication having a high range can be obtained. Further, the compensation circuit can use optical receiving components since this omits the need for using, e.g., photodiodes with low barrier layer capacitance to obtain high data rates during optical-wireless transfer.

According to an embodiment, the compensation circuit is configured to counteract a variation of a voltage across the one or several optical receiving components.

According to an embodiment, the compensation circuit comprises a transistor and a first impedance arrangement. A first terminal, such as an output of the one or several optical receiving components, is coupled to a control terminal, such as a gate terminal or a base terminal of the transistor. The first impedance arrangement or at least a component or an impedance element of the first impedance arrangement is connected between a first terminal, such as a source terminal or an emitter terminal of a controlled path of the transistor and a second terminal of the one or several optical receiving components, and a second terminal, such as a drain terminal or a collector terminal of the controlled path of the transistor is coupled to a reference potential conductor. The second terminal of the controlled path of the transistor is coupled to the reference potential conductor, e.g., directly or via one or several further components, such as a coil. The first impedance arrangement comprises, e.g., a capacitor and a resistor, wherein the capacitor serves as impedance element. The resistor of the first impedance arrangement is coupled, e.g. between the first terminal of a transistor and a bias. Alternatively, the first impedance arrangement comprises only one capacitor or resistor or a parallel connection of the capacitor and the resistor.

According to an embodiment, the compensation circuit comprises a second impedance arrangement to separate the one or several optical receiving components from a supply voltage or a supply voltage feed. This allows to a voltage at the one or several optical receiving components keep at least partly constant by means of the compensation circuit.

According to an embodiment, the compensation circuit is configured such that less direct voltage drops across the second impedance arrangement than across the first impedance arrangement and/or across the transistor and/or optionally across a coil coupled between the second terminal of the controlled path of the transistor and the reference potential conductor, wherein the compensation circuit comprises the first impedance arrangement, the transistor and optionally the coil. Thereby, a large bias across the one or several optical receiving components is obtained, whereby again the barrier layer capacitance of the one or several optical receiving components remains low.

According to an embodiment, the second impedance arrangement comprises a coil and/or a series connection of a resistor and a coil.

According to an embodiment, the first impedance arrangement comprises a capacitor and a resistor, wherein the capacitor and the resistor are connected to a first terminal of a transistor and wherein the resistor is further coupled to a bias. Alternatively, the first impedance arrangement comprises a parallel connection of the resistor and the capacitor. The compensation circuit is configured such that the second impedance arrangement comprises an impedance that is, e.g. regarding its value, equal to or greater than the resistor of the first impedance arrangement. The impedance of the second impedance arrangement is, e.g., at an operating frequency of the receiver circuit, i.e., for example, at a frequency of optical signals for the reception which the receiver circuit is configured to receive, or, for example, at the cutoff frequency of the optical receiving component, equal to or greater than the resistor of the first impedance arrangement. The impedance of the second impedance arrangement is, e.g., by a factor of at least 1, 5, 10 or 100 greater than the resistor of the first impedance arrangement. That way, the high-frequency compensation current, e.g., does not flow out of the first impedance arrangement across the second impedance arrangement into the supply voltage but actually flows, e.g., into the capacitance/capacitances of the one or several optical receiving components.

According to an embodiment, the first impedance arrangement comprises a capacitor and a resistor, wherein the capacitor and the resistor are connected to a first terminal of a transistor and wherein the resistor is further coupled to a bias. Alternatively, the first impedance arrangement comprises a parallel connection of the resistor and the capacitor. The compensation circuit is configured such that the capacitor of the first impedance arrangement comprises a capacitance that is greater than a sum of the capacitances of the one or several optical receiving components. The capacitance of the capacitor is, e.g., by a factor of at least 5, 10, 100 or 1000 greater than the sum of capacitances of the one or several optical receiving components to ensure a fast charge transfer.

According to an embodiment, the compensation circuit comprises a capacitor that is coupled to the control terminal of the transistor and that, for example, is also coupled to the reference potential conductor or a conductor with a direct voltage conductor, for example directly or via one or several further components.

According to an embodiment, a capacitor lies between control terminal and a reference potential. This capacitor forms an oscillator circuit, in sum with all other effective capacitors with a coupling coil of an inductive coupling arrangement. According to an embodiment, the coupling coil has the same or similar effect as the coil in the driver circuit.

According to an embodiment, the capacitor is coupled between the control terminal of the transistor and the second terminal, such as a collector terminal or a drain terminal of the controlled path of the transistor. This effects, for example, inverse feedback between the second terminal of the controlled path and the control terminal or as additional base-collector capacitance or gate-drain capacitance. According to an embodiment, the capacitor that is coupled to the control terminal of the transistor is configured to at least partly compensate a low-pass behavior of the amplifier circuit. By the inverse feedback, e.g., the bandwidth is increased. According to an embodiment, the capacitor that is coupled to the control terminal of the transistor is configured to compensate the low-pass behavior of the amplifier circuit together with an inductive coupling arrangement.

According to an embodiment, the capacitor that is coupled to the control terminal of the transistor is configured to realize a maximum in a frequency response of the compensation circuit or a circuit part that includes the compensation circuit and one or several optical receiving components. As already explained above, the frequency response is, e.g., the ratio of a current flowing from the one or several optical receiving components in the direction of the amplifier circuit, divided by the optical input signal. The circuit part represents, for example a control circuit. The maximum is, e.g., at a frequency range where a transfer characteristic of the amplifier circuit decreases, whereby this decrease can at least partly be compensated. According to an embodiment, the capacitor that is coupled to the control terminal of the transistor is configured to realize the maximum in the frequency response of the compensation circuit or the circuit part together with an inductive coupling arrangement.

According to an embodiment, the compensation circuit comprises a coil that is coupled between the second terminal of the controlled path of the transistor and the reference potential conductor. The coil is coupled to the reference potential conductor, e.g., directly or via one or several further components.

According to an embodiment, the coil that is coupled between the second terminal of the controlled path of the transistor and the reference potential conductor is configured to at least partly compensate a low-pass behavior of the amplifier circuit. The coil forms, e.g. an oscillator circuit with the capacitor that is coupled to the control terminal of the transistor to compensate the low-pass behavior. According to an embodiment, the coil contributes to an inductive peak behavior (“inductive peaking”) of an inductive coupling arrangement.

According to an embodiment, the coil that is coupled between the second terminal of the controlled path of the transistor and the reference potential conductor is configured to realize a maximum in a frequency response of the compensation circuit or a circuit part that includes the compensation circuit and the one or several optical receiving components. The frequency response can also be defined as described above. The maximum lies, e.g., in a frequency range where a transfer characteristic of the amplifier circuit decreases whereby this decrease can be at least partly compensated.

According to an embodiment, the capacitor that is coupled to the control terminal of the transistor and/or the coil that is coupled between the second terminal of the controlled path of the transistor and the reference potential conductor is configured such that the maximum in the frequency response of the compensation circuit or of a circuit part that includes the compensation circuit and the one or the several optical receiving components is at a frequency that deviates by at most 80% or by at most 40% or by at most 20% from a cutoff frequency of the one or several optical receiving components. The cutoff frequency of the one or several optical receiving components results here and, e.g., in the following, for example, from a combination of the one or several optical receiving components with the amplifier circuit, for example due to the capacitance of the one or several optical receiving components and the resistor of the amplifier circuit. Alternatively, here and, e.g., in the following, the cutoff frequency of the one or several optical receiving components is a cutoff frequency of the circuit arrangement that would result without the capacitor that is coupled to the control terminal of the transistor and without the coil that is coupled to the second terminal of the controlled path of the transistor. Thereby, a low-pass behavior of the amplifier circuit can be at least partly compensated. According to an embodiment, the capacitor and/or the coil contributes to an inductive peak behavior (“inductive peaking”) of an inductive coupling arrangement.

According to an embodiment, the capacitor that is coupled to the control terminal of the transistor and/or the coil that is coupled between the second terminal of the controlled path of the transistor and the reference potential conductor is configured such that the maximum in the frequency response of the compensation circuit or of a circuit part that includes the compensation circuit and the one or several optical receiving components is at a frequency that is greater than the cutoff frequency of the one or several optical receiving components. Thereby, a low-pass behavior of the amplifier circuit can at least be partly compensated. According to an embodiment, the capacitor and/or the coil contributes to an inductive peak behavior (“inductive peaking”) of an inductive coupling arrangement.

According to an embodiment, the capacitor that is coupled to the control terminal of the transistor and the reference potential conductor and/or the coil that is coupled between the second terminal of the controlled path of the transistor and the reference potential conductor is configured such that the maximum in the frequency response of the compensation circuit or a circuit part that includes the compensation circuit and the one or several optical receiving components is at a frequency that is less than 120% or 150% or 200% of the cutoff frequency of the one or several optical receiving components. Thereby, a low-pass behavior of the amplifier circuit can at least partly be compensated already at the start. According to an embodiment, the capacitor and/or the coil contributes to an inductive peak behavior (“inductive peaking”) of an inductive coupling arrangement.

According to an embodiment, the receiver circuit comprises an inductive coupling arrangement having at least one coupling coil that is connected between at least one of the one or several optical receiving components and the amplifier circuit. The inductive coupling arrangement is configured to generate a maximum in a frequency response to at least partly compensate a low-pass behavior of the amplifier circuit. The inductive coupling arrangement is, e.g., configured to realize an inductive peak behavior (“inductive peaking”) or an inductive voltage elevation. Optionally, the inductive coupling arrangement can be supplemented by all features, functionalities and details that are disclosed herein.

According to an embodiment, the inductive coupling arrangement comprises a capacitor that is coupled to the control terminal of the transistor of the compensation circuit, wherein the coupling coil and the capacitor that is coupled to the control terminal of the transistor are configured to form a first oscillator circuit.

According to an embodiment, the capacitor that is coupled to the control terminal of the transistor is configured to at least partly compensate a low-pass behavior of the amplifier circuit together with the coupling coil.

According to an embodiment, the capacitor that is coupled to the control terminal of the transistor is configured to realize, together with the coupling coil, a maximum in a frequency response of the compensation circuit or a circuit part that includes the compensation circuit and the one or the several optical receiving components.

According to an embodiment, the inductive coupling arrangement comprises a branch circuit path that comprises a capacitor, wherein the branch circuit path is coupled between a circuit node that is electrically between the one or the several optical receiving components and the coupling coil on the one hand and a supply potential or a reference potential on the other hand.

According to an embodiment, the coupling coil is configured to form a first oscillator circuit together with the capacitor that is coupled to the control terminal of the transistor and/or with the capacitor of the branch circuit path and/or together with one or several further capacitances. The first capacitances can, e.g., be a coupling capacitance and/or a capacitance of the one or several optical receiving components and/or a capacitance of the transistor of the compensation circuit, wherein the coupling capacitance can be connected, e.g., between a terminal of the one or several optical receiving components and the coupling coil. The oscillator circuit counteracts, e.g., a low-pass behavior of the amplifier circuit.

According to an embodiment, a resonant frequency of the first oscillator circuit is selected to at least partly compensate an effect of a capacitance of the one or several optical receiving components and/or to at least partly compensate a low-pass behavior of the amplifier circuit.

According to an embodiment, the first oscillator circuit is configured such that the maximum in the frequency response of the compensation circuit or a circuit part that includes the compensation circuit and the one or several optical receiving components is at a frequency that deviates by at most 80% or by at most 40% or by at most 20% from a cutoff frequency of the one or several optical receiving components.

According to an embodiment, the first oscillator circuit is configured such that the maximum in the frequency response of the compensation circuit or a circuit part that includes the compensation circuit and the one or the several optical receiving components is at a frequency that is greater than the cutoff frequency of the one or several optical receiving components.

According to an embodiment, the first oscillator circuit is configured such that the maximum in the frequency response of the compensation circuit or a circuit part that includes the compensation circuit and the one or the several optical receiving components is at a frequency that is less than 120% or 150% or 200% of the cutoff frequency of the one or several optical receiving components.

According to an embodiment, the coil that is coupled between the second terminal of the controlled path of the transistor and the reference potential conductor and the applied capacitances form a second oscillator circuit, wherein a resonant frequency of the second oscillator circuit is selected to at least partly compensate an effect of a capacitance of the one or the several optical receiving components and/or to at least partly compensate a low-pass behavior of the amplifier circuit.

According to an embodiment, a feedback path of the amplifier circuit comprises a series connection of a coil component and an impedance arrangement. The impedance arrangement comprises at least one capacitor and/or a resistor and the coil component is configured to at least partly compensate a low-pass behavior of the amplifier circuit. Optionally, the feedback path can be supplemented by all features, functionalities and details disclosed herein.

One embodiment relates to a receiver circuit for one or several optical receiving components for optical-wireless communication. The receiver circuit comprises an amplifier circuit that is configured to obtain an amplified output signal, such as an amplified voltage signal or an amplified current signal, based on a current provided by the one or several optical receiving components. The amplifier circuit comprises, e.g. a transimpedance amplifier. Further, the receiver circuit comprises an inductive coupling arrangement with at least one coupling coil that is connected between at least one of the one or several optical receiving components and the amplifier circuit. The inductive coupling arrangement is configured to generate a maximum in a frequency response to at least partly compensate a low-pass behavior of the amplifier circuit. The inductive coupling arrangement can comprise features and functionality as described above or in the following.

This embodiment of the receiver circuit is based on the finding that by the inductive coupling arrangement a high transimpedance amplification can be realized at high bandwidth by means of the amplifier circuit since the low-pass behavior of the amplifier circuit can be at least partly compensated. The inductive coupling arrangement allows a receiver circuit that obtains a higher bandwidth at the same amplification or that obtains a higher amplification at the same bandwidth. The bandwidth of the receiver circuit can be increased, e.g., by compensating an applied capacitance by the inductive coupling arrangement, i.e. both form an oscillator circuit. The applied capacitance can comprise, e.g., one or several capacitors of the receiver circuit and/or parasitic capacitances.

According to an embodiment, a high-pass is arranged between the one or several optical receiving components and the inductive coupling arrangement. The high-pass is coupled, e.g. to a first terminal of the one or several optical receiving components and the inductive coupling arrangement. Thereby, e.g., a direct component of a signal detected by the one or several optical receiving components is attenuated, which, e.g., can reduce noise.

According to an embodiment, the high-pass is configured to at least partly attenuate a photocurrent that originates from the ambient light detected by means of the one or several optical receiving components. Thereby, noise can be reduced.

According to an embodiment, the inductive coupling arrangement is configured to at least partly compensate a capacitance of a capacitor of the high-pass. Optionally, as an alternative or in addition, a capacitance of the one or several optical receiving components can be compensated. The inductive coupling arrangement can form one or several oscillator circuits with the capacitances to realize this compensation.

According to an embodiment, the coupling coil is configured to form a first oscillator circuit, together with a capacitor that is coupled to a control terminal of a transistor of a compensation circuit and/or with a capacitor that is coupled between a circuit node that is electrically between the one or the several optical receiving components and the coupling coil on the one hand and a supply potential or reference potential on the other hand and/or with one or several further capacitances of the receiver circuit.

According to an embodiment, a resonant frequency of the first operating circuit is selected to at least partly compensate an effect of a capacitance of the one or the several optical receiving components and/or to at least partly compensate a low-pass behavior of the amplifier circuit.

According to an embodiment, the inductive coupling arrangement comprises an inductance that deviates by at most 80% or by at most 40% or by at most 20% from a calculated inductance, according to

$$L = \frac{1}{{( 2 π f )}^{2} ( {C}_{PD , eff} + {C}_{in} + {C}_{par} )}$$

C_{PD,eff} represents the effective capacitance of the one or several optical receiving components. Cᵢₙ represents the input capacitance of the amplifier circuit. Cₚₐᵣ includes the applied effective parasitic capacitances and an optional capacitance for a capacitor that is coupled between a circuit node that is electrically between the one or several optical receiving components and the coupling coil on the one hand and a supply potential or a reference potential on the other hand. The frequency f is the frequency where the low-pass behavior of the amplifier circuit occurs.

One embodiment relates to a receiver circuit for one or several optical receiving components for optical-wireless communication. The receiver circuit comprises an amplifier circuit that is configured to obtain an amplified output signal based on a current provided by the one or several optical receiving components. A feedback path of the amplifier circuit comprises a series connection of a coil component and an impedance arrangement and the impedance arrangement comprises at least one capacitor and/or one resistor.

This embodiment of the receiver circuit is based on the finding that by the coil component, a high transimpedance amplification can be realized at high bandwidth by means of the amplifier circuit, since the low-pass behavior of the amplifier circuit can be at least partly compensated. Additionally, e.g., by the amplifier circuit, the current provided by the one or several optical receiving components is converted into a voltage signal and amplified by an impedance of the series connection to obtain the amplified output signal. The coil component enables the realization of a high impedance without or only little reduction of the bandwidth can be realized since, among others, the impedance of the coil component increases with increasing frequency. Thereby, a low-pass behavior of the amplifier circuit can be at least partly compensated.

According to an embodiment, the coil component is configured to at least partly compensate a low-pass behavior of the amplifier circuit. The coil component is, for example, configured to at least partly compensate a decrease of a transfer function of the amplifier circuit in the frequency spectrum. With the coil component, e.g., with increasing frequency, the amplification is also increased such that a decrease can be at least partly compensated.

According to an embodiment, the coil component is configured to increase a transimpedance of the amplifier circuit with increasing frequency.

According to an embodiment, the impedance arrangement comprises a parallel connection of a resistor and a capacitor.

According to an embodiment, the amplifier circuit comprises a differential amplifier. A first feedback path runs from a first output to a first input. A second feedback path runs from a second output to a second input. The first feedback path comprises the series connection of the coil component and the impedance arrangement and the second feedback path comprises a further series connection of the coil component and the impedance arrangement.

One embodiment provides a method for controlling one or several optical transmitting components. The method comprises providing a current controlled by an input quantity. A circuit used when adjusting the current comprises a maximum at a predetermined frequency, for example to at least partly compensate, e.g., a low-pass characteristic of the one or several optical transmitting components or the optoelectronic components in a transfer system.

One embodiment provides a method for receiving an optical signal by using one or several optical receiving components for optical-wireless communication. The method comprises at least partly compensating an effect of a capacitance of the one or several optical receiving components. Compensating comprises, e.g., accelerating a recharge of the capacitance. Compensating takes place, e.g., by reducing a variation of a voltage across the one or several optical receiving components. The method further comprises amplifying to obtain an amplified output signal based on the current provided by the one or several optical receiving components. During compensating, a maximum is generated in a frequency response to at least partly compensate a low-pass behavior of the amplifier circuit. The low-pass behavior that is at least partly compensated by the method typically results, e.g., from a cooperation of the optical receiving components provided with the capacitance and the transimpedance amplifier. The frequency response represents, e.g., a ratio between a current provided to the amplifier circuit and an optical input signal detected by the one or several optical receiving components.

Although some aspects have been described in the context of an apparatus, it is obvious that these aspects also represent a description of the corresponding method, such that a block or device of an apparatus also can be considered as a respective method step or as a feature of a method step.

### BRIEF DESCRIPTION OF THE DRAWINGS

Embodiments of the present invention will be detailed subsequently referring to the appended drawings, in which:

FIG. 1 is a schematic block diagram of a driver circuit for one or several optical transmitting components according to an embodiment of the present invention:

FIG. 2 is a schematic block diagram of a receiver circuit with a compensation circuit for one or several optical receiving components for optical-wireless communication according to an embodiment of the present invention;

FIG. 3 is a schematic block diagram of a receiver circuit with an inductive coupling arrangement for one or several optical receiving components for optical-wireless communication according to an embodiment of the present invention;

FIG. 4 is a schematic block diagram of a receiver circuit comprising an amplifier circuit with a control circuit for one or several optical receiving components for optical-wireless communication according to an embodiment of the present invention;

FIG. 5 is a schematic diagram of an optical-wireless transmitter with a driver circuit for one or several optical transmitting components of the transmitter according to an embodiment of the present invention;

FIG. 6a is a schematic diagram with transfer functions of different circuit paths of a driver circuit and/or a receiver circuit during compensation with high accuracy according to an embodiment of the present invention;

FIG. 6b is a schematic diagram with transfer functions of different circuit paths of a driver component and/or a receiver circuit during compensation with less accuracy than in FIG. 6a according to an embodiment of the present invention;

FIG. 7a is a schematic diagram of a receiver circuit with a compensation circuit, an inductive coupling arrangement and an amplifier circuit according to an embodiment of the present invention;

FIG. 7b is a schematic diagram of a receiver circuit with a compensation circuit, an alternative inductive coupling arrangement and an amplifier circuit according to an embodiment of the present invention;

FIG. 7c is a schematic diagram of a receiver circuit with an alternative compensation circuit, an inductive coupling arrangement and an amplifier circuit according to an embodiment of the present invention;

FIG. 8 is a schematic diagram of an optical-wireless communication path according to an embodiment of the present invention;

FIG. 9a is a block diagram of a method for controlling one or several optical transmitting components according to an embodiment of the present invention; and

FIG. 9b is a block diagram of a method for receiving an optical signal according to an embodiment of the present invention.

### DETAILED DESCRIPTION OF THE INVENTION

Before embodiments of the present invention will be discussed in more detail below with reference to the drawings, it should be noted that identical, functionally equal or equal elements, objects and/or structures are provided with the same or similar reference numbers in the different figures, such that the description of these elements illustrated in different embodiments is inter-exchangeable or inter-applicable.

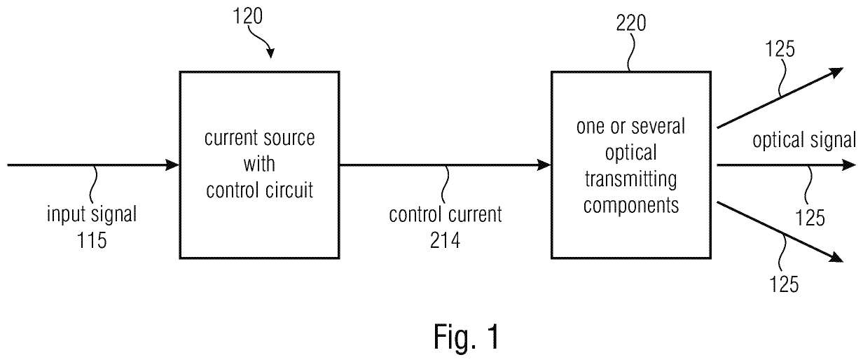

FIG. 1 shows a schematic illustration of a driver circuit 120 or control circuit for one or several optical transmitting components 220. The driver circuit 120 is connected to the one or several optical transmitting components 220 and comprises a controlled current source with control circuit.

A driver circuit 120 receives an input signal 115 that can be a current signal or a voltage signal. The input signal 115 controls the current source of the driver circuit 120 and the driver circuit 120 provides a control current 240 for the one or several optical transmitting components 220 based on the input signal 115.

Based on the control current 214, the one or several optical transmitting components 220 emit an optical signal 125.

The control circuit is configured such that a transfer characteristic of the driver circuit 120 has a maximum at a predetermined frequency. The transfer characteristic of the driver circuit represents, e.g., a ratio between the control current 214 and the input signal 115. Thereby, a low-pass characteristic of the one or several optical transmitting components 220 can be at least partly compensated and hence an optical signal 125 with high power and, e.g., without bit errors can be realized even at high frequencies, whereby optical-wireless communication with high range and large bandwidth can be ensured.

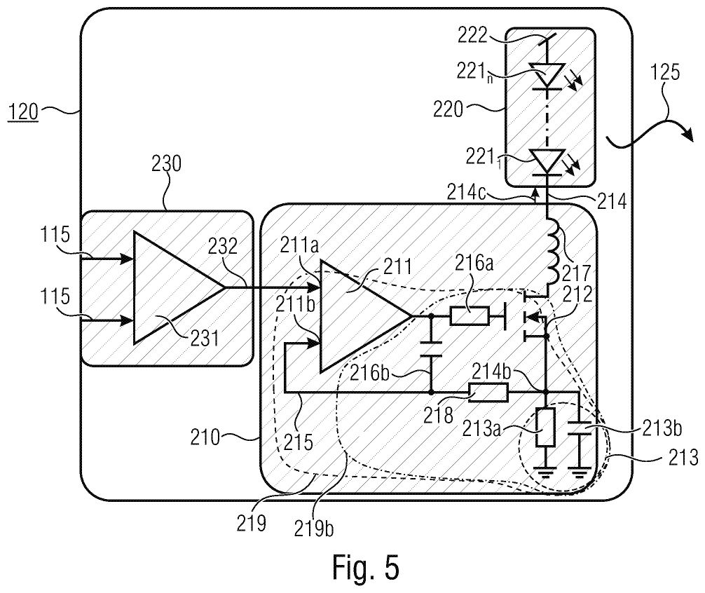

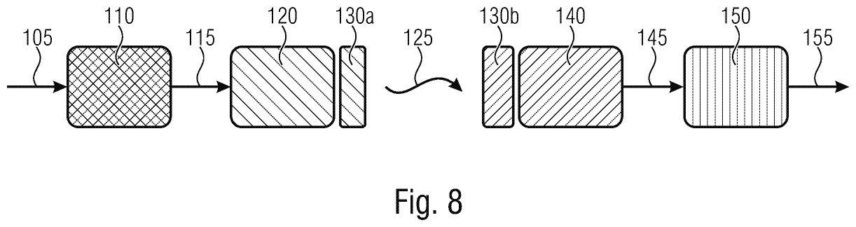

The driver circuit 120 can comprise features and functionalities as described in FIGS. 5 and 8.

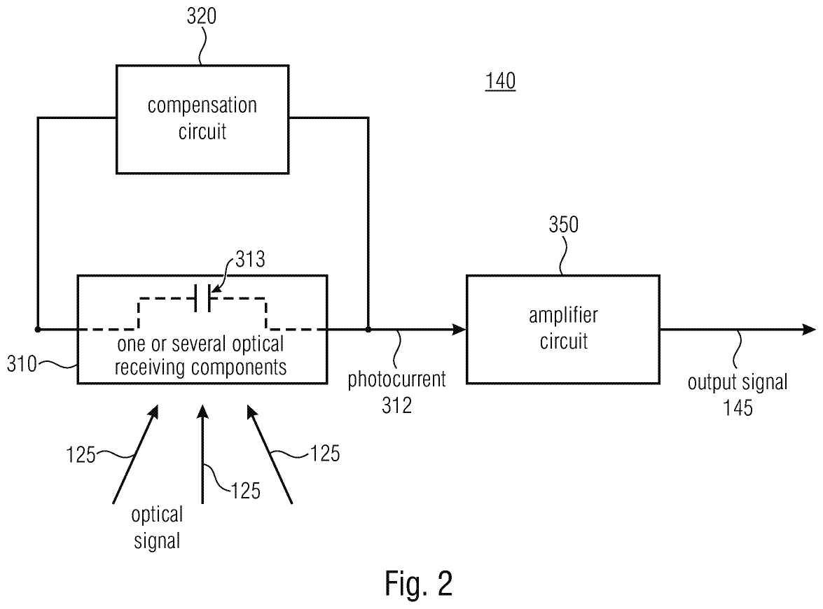

FIG. 2 shows a schematic representation of a receiver circuit 140 for one or several optical receiving components 310 for optical-wireless communication. If several optical receiving components 310 are used, the same can, for example, be connected in parallel. The receiver circuit 140 comprises, e.g., a compensation circuit 320 and an amplifier circuit 350.

The compensation circuit 320 is coupled to at least one of the one or several optical receiving components 310 with two terminals. Here, the compensation circuit 320 can be connected, for example, in parallel to the one or several optical receiving components 310. The amplifier circuit 350 is connected, e.g., in series to the one or several optical receiving components 310.

An optical signal 125 is detected via the one or several optical receiving components 310 and further processed, e.g., as photocurrent 312. The photocurrent 312 is provided both to the compensation circuit 320 as well as to the amplifier circuit 350. The amplifier circuit 350 amplifies the photo current and provides an output signal 145. The output signal 145 can represent a voltage signal or an amplified current signal. According to an embodiment, the photocurrent 312 controls a compensation of the compensation circuit 320.

The one or several optical receiving components 310 comprise, e.g., a parasitic capacitance 313. Thereby, part of the photocurrent 312 generated when detecting the optical signal 125 is lost when charging or discharging this parasitic capacitance 313. If several optical receiving components 310 are connected in parallel, the overall capacitance of all parasitic capacitances 313 is greater than for every single parasitic capacitance 313. The overall capacitance is equal to the sum of the individual capacitances.

The compensation circuit 320 is configured to at least partly compensate an effect of the parasitic capacitance 313 of the one or several optical receiving components. In that way, the compensation circuit can, for example, provide for an accelerated recharge of the capacitance or, for example, reduce a variation of a voltage across the one or several optical receiving components 310.

Further, the compensation circuit 320 is configured to generate a maximum in a frequency response to at least partly compensate a low-pass behavior of the amplifier circuit 350. The frequency response represents, e.g., a quotient between the photocurrent 312 and the optical signal 125, such as an optical power.

According to an embodiment, the compensation circuit 320 is configured to compensate the low-pass behavior resulting from the cooperation of the photodiode provided with a capacitance and the amplifier circuit 350.

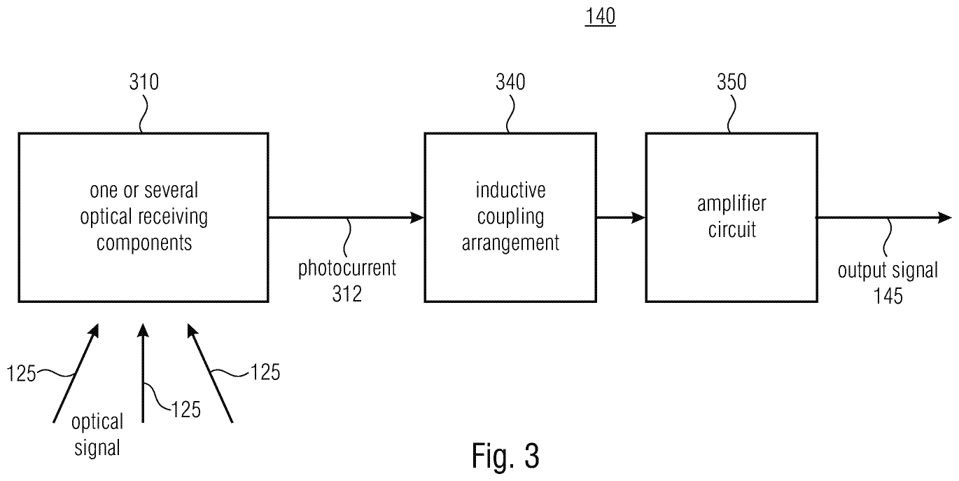

The receiver circuit 140 can comprise features and functionalities as described in FIGS. 3, 4, 7 and 8.

FIG. 3 shows a schematic illustration of a receiver circuit 150 for one or several optical receiving components 310 for optical-wireless communication. Several optical receiving components 310 are connected, e.g., in parallel. The receiver circuit 140 comprises an inductive coupling arrangement 340 and an amplifier circuit 350. The optical receiving components 310 as a whole, the inductive coupling arrangement 340 and the amplifier circuit 350 are connected in series.

An optical signal 125 is detected by means of the one or several optical receiving components 310 and passed on to the inductive coupling arrangement 340 and the amplifier circuit 350 as photocurrent 312 to provide an amplified output signal 145. Here, the inductive coupling arrangement 340 is, for example, upstream of the amplifier circuit 350.

The inductive coupling arrangement 340 is configured to generate a maximum in a frequency response to at least partly compensate a low-pass behavior of the amplifier circuit 350.

The receiver circuit 140 can comprise features and functionalities as described in FIGS. 2, 4, 7 and 8.

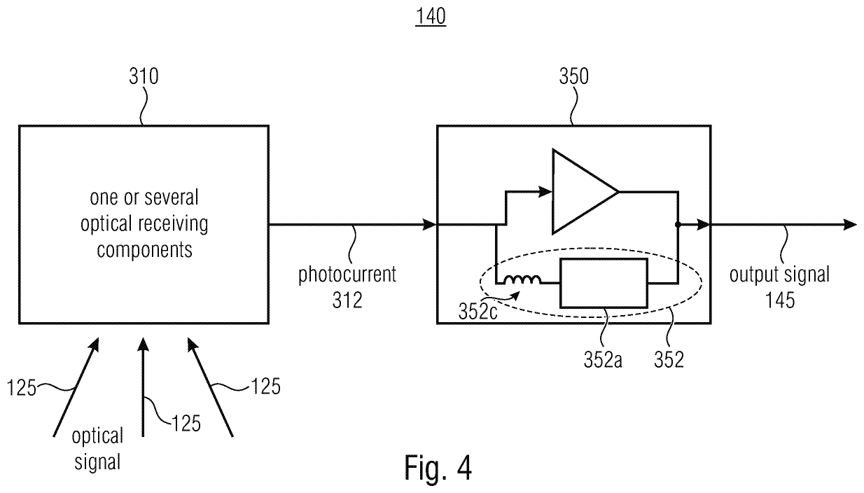

FIG. 4 shows a schematic illustration of a receiver circuit 140 for one or several optical receiving components 310 for optical-wireless communication. The receiver circuit 140 comprises an amplifier circuit 350 that is coupled, e.g., to the one or several optical receiving components 310. Further, the amplifier circuit 350 comprises a feedback path 352 by which a signal, e.g., can be fed back to influence an amplification of the amplifier circuit 350. The feedback path of the amplifier circuit comprises a series connection of a coil component 352c and an impedance arrangement 352a. Here, the impedance arrangement 352a can comprise, e.g., a resistor or a parallel connection of a resistor and a capacitor.

The one or several optical receiving components 310 are configured to detect an optical signal 125 and to provide a photocurrent 312 based thereon. The photocurrent 312 is amplified, e.g., by the amplifier circuit 350 to obtain an amplified output signal 145.

The feedback path 352 cannot only influence the amplification but also a bandwidth. The coil component has a specific significance, by which the amplification is significantly higher at high frequencies compared to lower frequencies, whereby a low-pass characteristic of the amplifier circuit can be at least partly compensated.

The receiver circuit 140 can comprise features and functionalities as described in FIGS. 2, 3, 7 and 8.

FIG. 5 represents a schematic illustration of an optical-wireless transmitter 120 with an optical-wireless transmitting component block 220, an amplifier stage 230 and a controlled current source 210. According to an embodiment, the optical-wireless transmitting component block 220, the amplifier stage 230 and the controlled current source 210 are connected in series in this order. A driver circuit for optical transmitting components of the optical-wireless transmitting component block 220 comprises, e.g., the amplifier stage 230 and the current source 210 with a control circuit 219.

A data signal 115 is preprocessed, e.g., by the amplifier stage 230, such as a superposition of the data signal 150 with a bias or performing pre-equalization. The amplifier stage 230 provides an input signal 232 to the controlled current source 210, which can be a current signal or a voltage signal.

The input signal 232 controls the current source 210, such that the same can provide a control signal 214c to the optical-wireless transmitting component block 220. Here, the control circuit 219 of the current source 210 is configured to at least partly compensate a low-pass characteristic of the optical-wireless transmitting component block 220 and/or of optoelectronic components in a transfer system. This means, e.g., that the current source provides a higher current over the control signal 214c at high frequencies compared to lower frequencies. The control circuit 219 can comprise the feedback network 219b. The feedback network 219b is configured, e.g., to feedback a feedback signal based on the current for the one or several optical transmitting components, such as the control signal 214c, to a feedback input of the differential amplifier.

Based on the control signal 214c, the optical-wireless transmitting component block 220 emits an optical signal 125. Further, the optical-wireless transmitting component block 220 is connected, e.g., to a supply voltage 222.

The signal 115 fed into, for example, the driver circuit can be configured as individual wire or in a differential manner. In the latter case, the differential signal 115 is converted into an individual signal 232, e.g., by the amplifier. If the signal 115 is configured individually and no further pre-amplification is needed, the amplifier stage 230 can also consist only of an AC coupling (capacitance) and a voltage divider that adjusts a bias. Alternatively, in this case, a voltage adder is also possible as block 231. If the signal 115 is configured individually, and the bias is already included in the signal 115 and no further pre-amplification is needed, this block can be omitted.

A first input 211a of an operational amplifier 211 of the current source 210 is coupled to an output of the amplifier stage 230. An output of the operational amplifier is coupled back to a second input 211b (feedback input) of the operational amplifier 211 of the current source 210 via a capacitor 216b. The operational amplifier 211 is connected in series to a resistor 216a and the transistor 212 via its output, wherein the resistor 216a is coupled to a control terminal (e.g., a gate terminal or a base terminal) of the transistor 212. A path of the transistor, such as a source-drain path, can be controlled. A first terminal of the controlled path, such as a drain terminal, is coupled to the optical-wireless transmitting component block 220. Here, for example, a coil 217 of the current source is connected into an output current path. The coil is connected, for example, in series to optical transmitting components 221₁ to 221ₙ of the optical-wireless transmitting component block 220. A second terminal of the control path, such as a source terminal, is coupled to the second input 211b of the operational amplifier 211, e.g., via a resistor 218. As an alternative or in addition to the resistor 218, an impedance arrangement 213 is connected between the reference potential and the second terminal of the controlled path. The impedance arrangement 213 comprises, e.g., a resistor 213a or a parallel connection of the resistor 213a and a capacitor 213b. In this case, the resistor 218 is used for adapting the signal level of the feedback signal.

The optical transmitting components 221₁ to 221ₙ can be configured as light emitting diodes (LEDs).

The core of the optical-wireless transmitter 120 represents, for example, a controlled current source 210 that regulates a drain/collector current of the transistor 212, i.e., for example also the current in the path 214. The transistor is configured, e.g., to adjust a current for the one or several optical transmitting components. The path 214 extends from the current supply 222 up to the node 214b. The current source 210 is controlled by the signal 232 (e.g., an input voltage signal) that is fed into the first input 211a (positive/negative input) of the operational amplifier (op-amp) 211. The op-amp 211 again drives the gate/the base of the transistor 212. The transistor 212 can a MOSFET, BJT or a cascode circuit of MOSFET or BJT. Advantageously, a MOSFET is used. Above that, a specific power transistor (GaN) can be used to drive high currents, for example, in the ampere range.

The current source 210 is realized as control circuit, as part of the signal is fed back to the second input 211b of the amplifier 211. For this, e.g., a network, such as the impedance arrangement 213, is used, which, in the simplest case, consists of a resistor 213a. The feedback signal is illustrated as 215 and is fed into the negative/positive input 211b of the op-amp 211. The impedance arrangement 213 is configured, e.g., to generate a signal that is fed back to the feedback input of the differential amplifier, based on a current flow (that is transmitted, e.g., as control signal 214c to the optical-wireless transmitting component block 220) through a control path of the transistor 212.

The inductance, e.g., of the coil 217 in the strand 214 essentially determines the frequency response of the current in the strand 214. The same is present at all times, e.g. as parasitic inductance and results as a sum of the parasitic inductances of the conductor tracks and elements in the strand 214 and network 213. Conventionally, an attempt is made to keep this inductance as low as possible to obtain the maximum modulation bandwidth of the controlled current source 210 [1]. The approach presented herein, however, differs in that a relatively high inductance is accepted or even increased further by an additional coil 217. Thereby, a low-pass behavior of the optical transmitting components 221₁ to 221ₙ can be at least partly compensated.

When the transistor 212 is operated, e.g., in a source connection, the gate-drain capacitance is the dominant capacitance, since the same occurs as Miller capacitance. Due to the coil 217, a further effect results: The Miller capacitance depends, e.g., on the voltage amplification of the transistor, i.e., also on the load, i.e., the optical transmitting components 221₁ to 221ₙ and the coil 217. With increasing frequency, the impedance in this strand 214 increases, i.e., the voltage amplification becomes higher and hence also the Miller capacitance. This effect has, e.g., also an influence on the dynamics in the control circuit 219.

The following elements for the current source 210 are optional:
The dynamics of the control circuit can be adjusted by the optional network 216. The elements 216a (resistor) and 216b (capacitance) form a low-pass between the operational amplifier 211 and the transistor 212. Above that, the cooperation of the resistor 216a and the input capacitance of the transistor 212 (gate/base capacitance, effective Miller capacitance) decisively influences the dynamics of the control circuit 219.
Optionally, a resistor 218 can be used in the feedback path 219 to convert a feedback voltage into a current and to adapt its level. This can be needed when the negative/positive input 211b of the operational amplifier 211 is configured as low-resistance current input.
Optionally, a capacitance 213b can be placed parallel to the resistor 213a in the impedance arrangement 213. The capacitance 213b short-circuits, e.g., the resistor 213a for sufficiently large frequencies, such that a low portion in the form of a signal 215 is fed back in this frequency range (high frequencies). This can also influence the dynamics of the control circuit.

The transmitter 120 comprises a strand, such as the optical-wireless transmitting component block 220 in which one or several LEDs (221₁, . . . 221ₙ) are connected. The strand is connected, e.g., to a supply voltage 222 and connected to the drain/collector of the transistor 212 on the other side. By regulating the current through the strand 214, the controlled current source 210 also regulates the current through the LEDs 221₁, . . . 221ₙ. The LEDs convert the current through the strand 214 into the optical signal 125. The number of LEDs per strand 220 is arbitrary, for example, 1 to 50 LEDs, 20 to 100 LEDs or 1 to 20 LEDs can be connected in series, or for smaller systems, 1 to 7 LEDs are also possible. The optical output power per LED strand can be, for example, between 1 mW and 200 W, depending on the range that is to be bridged. Typical are 10 mW to 10 W or 100 mW to 1 W optical output power.

The optional amplifier stage 230 can be used to superpose the data signal with a bias that is converted into a bias current by the controlled current source. The same is useful to increase the modulation bandwidth of the LEDs. Compared to this, a driver circuit without control circuit would need an additional DC source adjusting the bias current. The same is not ideal, i.e., the same has an undesired input capacitance and its input resistance is not infinite. The present invention allows the omission of this additional direct current source as the bias current is adjusted, e.g., via the control circuit 219.

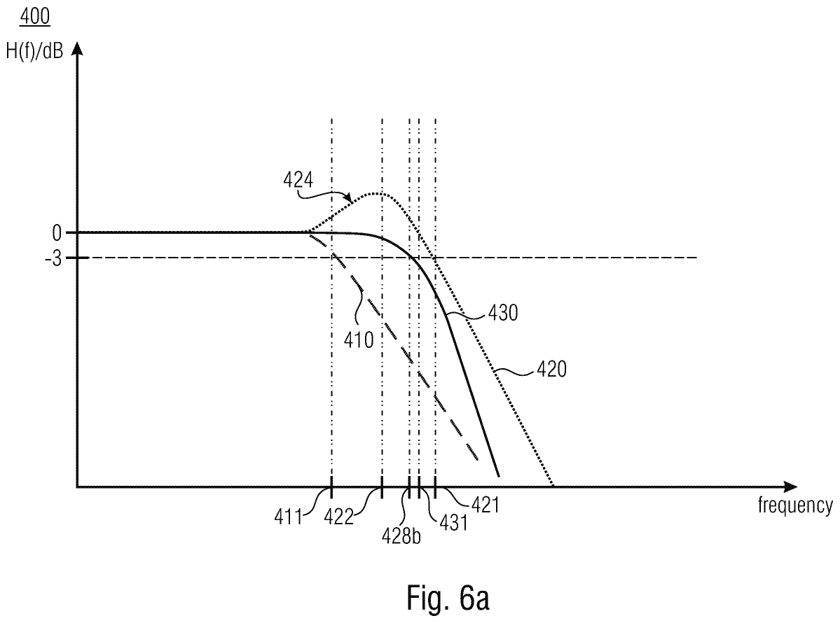

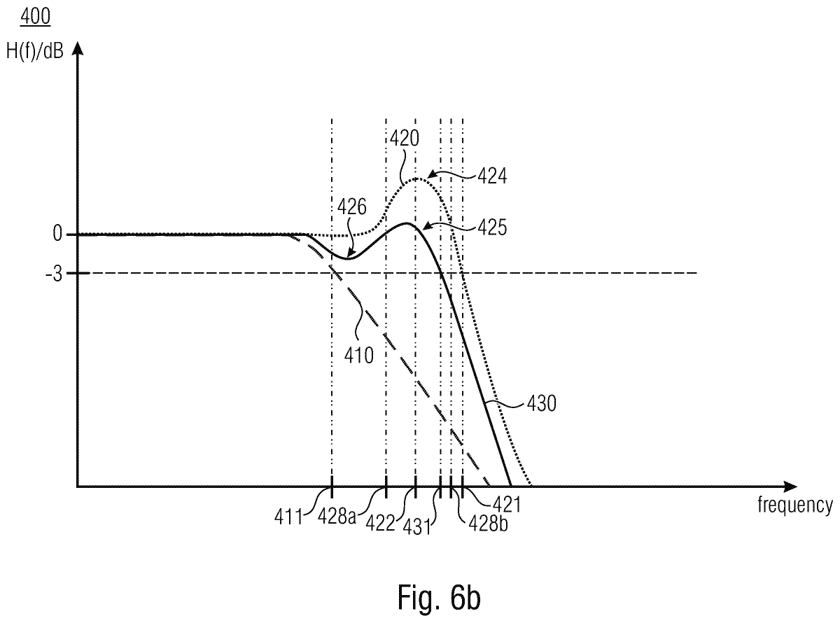

According to an embodiment, the resistor 216a and/or the capacitor 216b and/or the impedance arrangement 213 and/or the resistor 218 and/or the coil 217 are configured to obtain that the transfer characteristic of the driver circuit has a maximum at a predetermined frequency. Here, it is decisive that the control circuit 219 or the current source 210 is dimensioned such that the control circuit 219 or the current source 210 comprises overshoot at a resonant frequency that occurs approximately at a cutoff frequency of the LEDs. This is shown schematically in FIGS. 6a and 6b. In that way, the low-pass behavior of the LEDs can be compensated and the overall cutoff frequency 431 of the optical-wireless transmitter 120 can be increased, for example, to at least 90 MHz, at least 120 MHz, at least 200 MHz or more. Thereby, the transmitter is able, e.g., to transmit a 125 Mbps OOK Signal (On-Off-Keying-Signal) with cost effective LEDs. In that way, the driver circuit is configured to control, e.g., the one or several optical transmitting components 221₁ to 221ₙ such that an optical-wireless communication with high bandwidth is realized. FIG. 6a and FIG. 6b illustrate this principle.

The diagrams 400 show transfer functions of different circuit parts over the frequency spectrum, such as an overshoot of the controlled current source 210. The curve 410 shows the transfer function of an LED, i.e., the optical output signal 125 divided by the alternating portion of the forward current through the LED, i.e., the alternating current through path 214. In other words, the curve 410 can be referred to as optical transfer characteristic. The curve 410 comprises a low-pass behavior with a characteristic −3 dB cutoff frequency 411. The cutoff frequency 411 occurs, e.g., at a maximum of 1 MHz, at a maximum of 5 MHz, at a maximum of 10 MHz, at a maximum of 30 MHz, at a maximum of 50 MHz or the same.

The graph 420 describes the transfer function of the controlled current source 210, i.e., the alternating current driven through the path 214 divided by the voltage or current signal at the input. In other words, the graph 420 can be referred to as transfer characteristic of the driver circuit.

The curve 430 shows, e.g., the transfer function of the entire optical transmitter 120, i.e., the optical output signal 125 divided by the input signal 115. In other words, the curve 430 can be referred to as overall transfer characteristic of the transceiver.

Typically, an attempt would be made to maximize a cutoff frequency 421 of the control circuit 219 [2], for example to several tens of MHz or several hundreds of MHz. However, as the LEDs 221₁ . . . 221ₙ have a significantly lower cutoff frequency 411, the same are the dominant pole in the system, such that the overall cutoff frequency 431 of the optical-wireless transmitter 120 would not be sufficient to transmit, for example, a 125 Mbps OOK Signal. In the invention presented herein, the cutoff frequency of the control circuit 420 is not significant. Much more important is an elevation 424 of the graph 420, i.e., e.g., the maximum at a maximum frequency 420 and a range around the same.

FIG. 6a clearly shows that the transfer function 420 comprises an elevation 424 already at the cutoff frequency 411 of the LEDs, such that the low-pass behavior of the curve 410 is compensated. Thereby, the overall cutoff frequency 431 of the optical-wireless transmitter 120 is, e.g., significantly higher than the cutoff frequency 411 of the LEDs. Thus, it is possible to transmit, for example, a 125 Mbps OOK signal. Ideally, the elevation 424 of the graph 420 is selected to be exactly analog to the low-pass behavior of the curve 410.

It is also possible, as can be seen in FIG. 6b, that the elevation 424 is slightly weaker/stronger as long as the difference is within certain limits (at least in 6 dB interval, better in 3 dB, ideally less than 2 dB). Typically, the elevation is in the range of 0 dB to 20 dB, more frequently in the range of 0 dB to 12 dB, ideally in the range of 0 dB to 6 dB. The invention also includes the case where the elevation does not start in the same frequency range as the low-pass behavior (but already at lower/higher frequencies) and/or is stronger/weaker than the low-pass behavior, such that an elevation 425 (in a range of 0 dB to 20 dB, normally less is better)/local minima 426 (0 dB to 10 dB, normally less is more) in the transfer function 430 can result. Generally, elevation 425 of the curve 430 can be used, for example, to at least partly compensate low-pass behavior at the receiver.

As shown in FIGS. 6a and 6b, the control circuit 219 of the driver circuit can be configured to fulfil at least one of the following features:
The maximum of the transfer characteristic 420 of the driver circuit is at a frequency 422 that deviates by at most 80% or by at most 40% or by at most 20% from the cutoff frequency 411 of the one or several optical transmitting components.
The maximum of the transfer characteristic 420 of the driver circuit is at a frequency 422 that is greater than the cutoff frequency 411 of the one or several optical transmitting components.
The maximum of the transfer characteristic 420 of the driver circuit is at a frequency 422 that is less than 120% or 150% or 200% of the cutoff frequency 411 of the one or several optical transmitting components.
At a cutoff frequency 411 of the one or several optical transmitting components, the transfer characteristic 420 of the driver circuit comprises an elevation 424 compared to a value of the transfer characteristic 420 at a lower frequency, e.g., less than the cutoff frequency 411.
Compared to a value of the transfer characteristic 420, the transfer characteristic 420 of the driver circuit comprises an elevation 424 at a lower frequency, e.g., less than the cutoff frequency 411. The elevation 424 starts at a first frequency (411 in FIG. 6a) that is less than or equal to the cutoff frequency 411 of the one or several optical transmitting components and extends up to a second frequency (428b in FIG. 6a) that is greater than the cutoff frequency 411 of the one or several optical transmitting components.
Compared to a value of the transfer characteristic 420, the transfer characteristic 420 of the driver circuit comprises an elevation 424 at a lower frequency, e.g., less than the cutoff frequency 411. The elevation 424 starts at a frequency (428a in FIG. 6b) that is greater than the cutoff frequency 411 of the one or several optical transmitting components and that extends up to a higher frequency (428b in FIG. 6b).
A maximum elevation of the transfer characteristic 420 of the driver circuit is between 2 dB and 20 dB or between 2 dB and 12 dB or between 2 dB and 6 dB in relation to a value of the transfer characteristic 420 at a low frequency that is lower than the frequency (411 in FIG. 6a or 428a in FIG. 6b) where the elevation 424 starts.

The transfer characteristic 420 can correspond to the optical transfer characteristic of the one or several optical transmitting components or the optical transfer characteristic of the receiver circuit. Up to the cutoff frequency 411, the transfer characteristic 420 is essentially flat. The cutoff frequency 411 defines, for example, a start of a decrease of the curve of the transfer characteristic 410. If the transfer characteristic 410 is the optical transfer characteristic of the one or several optical transmitting components, the cutoff frequency 411 corresponds, for example, to a cutoff frequency of the one or several optical transmitting components. If the transfer characteristic 410 is the optical transfer characteristic of the receiver circuit, the cutoff frequency 411 corresponds, for example, to a cutoff frequency of the one or several optical receiving components in combination with the amplifier circuit or a cutoff frequency of the circuit arrangement without the coil that is coupled to the second terminal of the controlled path of the transistor. Alternatively, the cutoff frequency can be defined both at the optical transfer characteristic of the one or several optical transmitting components as well as at the optical transmitting components as well as at the optical transfer characteristic of the receiver circuit as follows. The cutoff frequency can define, for example, a −2 dB cutoff frequency, a −3 dB cutoff frequency or a −4 dB cutoff frequency. Here, the prefix −x dB (x∈[2,3,4]) relates, for example, to a value of the transfer characteristic 410 at a lower frequency than the cutoff frequency 411, such as a value in the essentially flat area of the transfer characteristic 410.

The transfer characteristic 420 of the driver circuit runs in an essentially flat manner up to a starting frequency 411 in FIG. 6a and 428 in FIG. 6b. From the starting frequency onwards, the transfer characteristic 420 of the driver circuit comprises an elevation 424 up to an end frequency 428b. From the end frequency 428b onwards, the transfer characteristic 420 of the driver circuit decreases further. The starting frequency, 411 in FIG. 6a and 428a in FIG. 6b and the end frequency 428b can, for example, define a +2 dB cutoff frequency, a +3 dB cutoff frequency or +4 dB cutoff frequency. Here, the prefix +x dB (x∈[2,3,4]) relates, for example, to a value of the transfer characteristic 410 at a lower frequency than the starting frequency, 411 in FIG. 6a and 428a in FIG. 6b, such as to a value in the essentially flat area of the transfer characteristic 410. The end frequency 428b corresponds to a higher frequency than the starting frequency 411 in FIG. 6a and 428a in FIG. 6b. The elevation 424 has the maximum at the frequency 422 between the starting frequency 411 in FIG. 6a and 428 in FIG. 6b and the end frequency 428b.

The overall transfer characteristic 430 results, for example, from a multiplication of the transfer characteristic 420 of the driver circuit with the optical transfer characteristic 410. Depending on the configuration of the driver circuit or the receiver circuit, a compensation can be realized with high accuracy as illustrated in FIG. 6a or only with little accuracy as illustrated in FIG. 6b. Depending on the requirements, this can be adapted to the optical-wireless communication.

As the elevation 424 of the transfer characteristic 420 of the driver circuit only starts at a frequency higher than the cutoff frequency 411, as can be seen in FIG. 6b, only a partial compensation exists in a range between the cutoff frequency and the starting frequency 428a. In this range, the transfer characteristic 420 of the driver circuit has, for example, a local minimum 426.

The overshoot 424 at and around the maximum frequency 422 of the transfer function 420 of the driver circuit results, e.g., from the interaction of the following parameters. By changing one or several of these parameters, the elevation 424 at and around the maximum frequency 422 can be specifically influenced:
1. Transfer function of the operational amplifier 211
2. Transfer function of the transistor 212, in particular, e.g., the input capacitance (effective Miller capacitance)
3. The load applied to the voltage-controlled current source 210, i.e., the sum of the impedances of block 220 and the inductance (coil) 217. For high frequencies, the same is essentially only formed by the overall inductance 217 of the strand 214
4. Dimensioning the components in the network 216
5. Dimensioning the components in the network 213 and optionally 218
6. Dimensioning the supply voltage 222 since the same has influence on the voltage that decreases across the LEDs 221₁ . . . 221ₙ and the transistor.

In practice, the process for dimensioning the components is as follows: First, it is determined how many LEDs are needed. This results already in the parasitic portion of the inductance 217. Now, an op-amp 211 and the transistor 212 are selected with sufficient bandwidth. Subsequently, the supply voltage 222 is determined. Now, the elevated range 424 of the graph 420 can be adapted by dimensioning the components in the network 216. If needed, an additional coil can be placed at 217. If these measures are not sufficient to sufficiently increase the bandwidth of the LED, there is the option of increasing the supply voltage 222 (which again increases the voltage across the transistor 212 and in that way increases its bandwidth) or of increasing the impedance of the network 213 (for example, higher resistance of 213a).

The resistor 216a determines how fast, e.g., the gate/base of the transistor 212 can be recharged. By selecting a higher resistance, the peak of the graph 420 can be shifted in the direction of lower frequencies in the frequency spectrum. Above that, the strength of the elevation is influenced. Practical values are in the one and two digit Ohm range. The capacitor 216b essentially influences the strength of the elevation and only slightly its position in the frequency range. The greater the capacitance the stronger, e.g., the elevation, since a greater part of the signal is fed back to the input 211b via the capacitance 216b. Practical values are in the one and two digit pF range. The coil/inductance 217 also influences the position of the elevation in the frequency range. Practical values are in the one digit/low two digit nH range for signals of >500 MHz and in the two digit nH range to pH range for signals in the frequency range 1 MHz . . . 500 MHz. Below that, the LED should be fast enough anyway.

Above that, further variations of the optical-wireless transmitter 120 are possible.
It is possible that there are several strands 220₁ . . . 220n of LEDs connected in series that are all connected to the drain/collector of the same transistor 212. Thus, the strands 220₁ . . . 220ₙ are connected in parallel.
It is possible that a transceiver comprises several voltage-controlled current sources 210₁ . . . 210ₙ, each comprising one or several strands 220₁ . . . 220ₙ of LEDs.
It is possible that a transceiver comprises several driver circuits that can again comprise one current source 210 or several current sources 210₁ . . . 210ₙ each, which again drive, e.g., an LED strand 220 or several LED strands 220₁ . . . 220ₙ.
Usage of a pre-equalization in the stage 230 or in block 110.

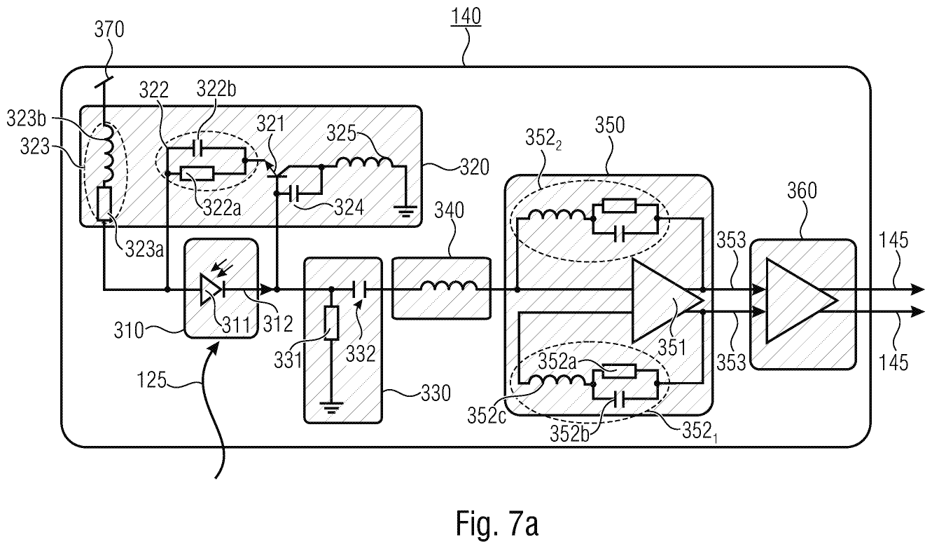

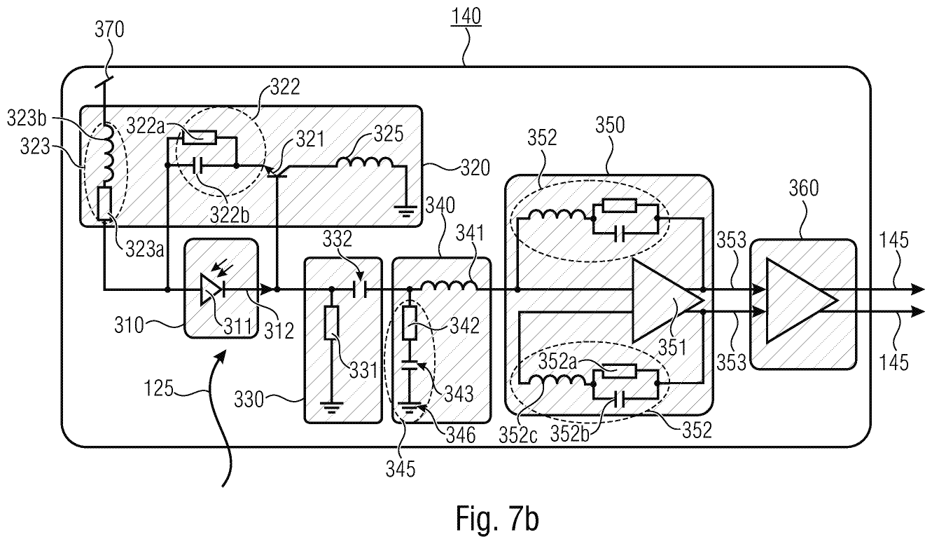

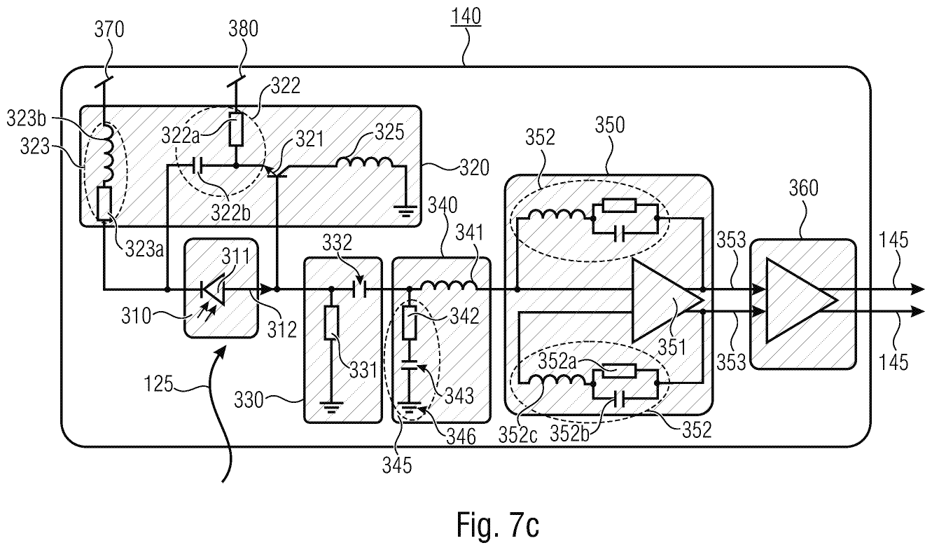

FIG. 7 shows a schematic illustration of a receiver circuit 140 for one or several optical receiving components 310 for optical-wireless communication. The receiver circuit 140 comprises, e.g., a compensation circuit 320, an inductive coupling arrangement 340 and an amplifier circuit 350. Optionally, the receiver circuit 140 comprises additionally a high-pass 330 and/or a further amplifier stage 360. According to an embodiment, the compensation circuit 320 is connected in parallel to the one or several optical receiving components 310. The one or several optical receiving components 310 can be connected in series to the high-pass 330, the inductive coupling arrangement 340, the amplifier circuit 350 and/or the further amplifier stage 360.

The one or several optical receiving components 310 can be configured to detect an optical signal 125 and to provide the same as photocurrent 312. The one or several optical receiving components 310 can have a parasitic capacitance. For the photocurrent 310 not to be attenuated completely or too heavily by the parasitic capacitance, the compensation circuit 320 is configured to compensate an effect of this parasitic capacitance.

The resulting photocurrent 312 flows through the high-pass 330 to filter out interference signals. Here, e.g., specifically the direct component is filtered out.

The inductive coupling arrangement 340 can form an oscillator circuit, e.g., with capacitances of the compensation circuit 320, the one or several optical receiving components 310 and/or the high-pass 330, to at least partly compensate a low-pass characteristic of the amplifier circuit 350.

Subsequently, the photocurrent can be amplified by means of the amplifier circuit 350 and/or the further amplifier stage 360 to obtain an amplified output signal 145.

According to an embodiment, the receiver circuit 140 comprises a supply voltage 370 that is coupled to the one or several optical receiving components 310 via a second impedance arrangement 323 of the compensation circuit. The second impedance arrangement 323 comprises, e.g., a resistor 323a or a series connection of the resistor 323a and a coil 323b.

A first terminal of a parallel connection of a first impedance arrangement 322 and a transistor 321 of the compensation circuit to the one or several optical receiving components 310 is arranged between the second impedance arrangement 323 and the one or several optical receiving components. This first terminal leads, e.g., first to the first impedance arrangement 322, then to a first terminal of a controlled path of the transistor 321 and via a control terminal of the transistor 321, the parallel connection to the one or several optical receiving components is closed. Optionally, the compensation circuit 320 comprises a capacitor 324 that is connected between the control terminal and the second terminal of the controlled path of the transistor 321. Optionally, the compensation circuit 320 comprises a coil 325 that is connected between the second terminal of the controlled path of the transistor 321 and a reference potential conductor. According to an embodiment, the capacitor 324 is connected with a terminal between the second terminal of the controlled path of the transistor 321 and the coil 325.

The first impedance arrangement 322 comprises a resistor 322a and/or a parallel connection of the resistor 322a and a capacitor 322b.

The terminal of the one or several optical receiving components 310 that is coupled to the control terminal of the transistor is coupled to a reference potential conductor, e.g., via a resistor 331 of the high-pass 330, and coupled to the inductive coupling arrangement 340 via a capacitor 332 of the high-pass 330.

The inductive coupling arrangement 340 can comprise, e.g., a coil. Alternatively, the inductive coupling arrangement 340 can also comprise a more complicated peaking network, such as a T coil peaking network, a Pi type peaking network or a triple resonance peaking network. Thus, the inductive coupling arrangement 340 can be connected between the capacitor 332 of the high-pass 330 and the first input of an operational amplifier 351 of the amplifier circuit 350.

The amplifier circuit 350 can comprise an operational amplifier (op-amp) 351 having two outputs 353 as illustrated in FIG. 7 or alternatively the same can comprise only one output. If the amplifier 351 comprises, e.g., only one output and one input, the output can be fed back to the input of the amplifier 351 via an impedance arrangement 352₁. If the transimpedance amplifier (TIA) is configured in a differential manner, i.e., the same has two outputs and two inputs, there are, e.g., two feedbacks, each from an output and the respective input. If the op-amp 351 comprises, for example, two outputs, a first output can be fed back to the second input of the op-amp 351 via the impedance arrangement 352₁ or additionally a second output can be fed back to the first input of the op-amp 351 via the further impedance arrangement 352₂. The impedance arrangement 352₁ and the further impedance arrangement 352₂ have, e.g., a series connection of a resistor 352a and a coil 352c. Alternatively, the impedance arrangement 352₁ and the further impedance arrangement 352₂ have a parallel connection of the resistor 352a and a capacitor 352b, wherein this parallel connection is connected in series with the coil 352c.

Optionally, an output signal 353 of the op-amp is guided to the amplifier stage 360 to be amplified further by the same. The amplifier stage 360 comprises, e.g., a limiting amplifier.

In the following, the receiver circuit 140 will be described in detail in other words.

The optical-wireless receiver (e.g., the receiver circuit 140) consists of a series of components of which the photo detector 310, in this case the photodiode 311, is obligatory in any case. The photo detector 310 detects the optical signal 125 and converts the same into the photo current 312. The supply voltage 370 is selected, e.g., such that the photodiode is connected in reverse direction (in this case, the same is negative, alternatively also positive when anode and cathode are exchanged). Here, the supply voltage 370 can be selected to be as high as possible (depending on how much the photodiode can tolerate) to maximize the bandwidth of the photodiode.

The photocurrent is converted into the voltage signal 353 by the transimpedance amplifier (e.g., the amplifier circuit 350) and amplified by the impedance of the partial network group (e.g., the impedance arrangement 352₁ and/or the further impedance arrangement 352₂). In the simplest case, this group consists merely of a resistor 352a. To influence the dynamics of the feedback, a capacitor 352b can be connected in parallel to the resistor 352a. The higher the resistance of the resistor 352a, the higher the amplification and the lower the noise, however, the bandwidth of the transimpedance amplifier 350 also decreases. The resistor is selected to be as high as possible, such that the receiver circuit 140 reaches the bandwidth needed for communication. The blocks/elements 320, 340 and 352a allow obtaining a higher bandwidth with the same amplification or a higher amplification with the same bandwidth. The resistance is typically in the kilo ohm range.

Optionally, the signal 353 can be amplified to a well-defined signal level by the further amplifier stage 360, which is predetermined by the respective communication standard. This amplifier stage 360 can be configured as limiting amplifier, i.e., as amplifier having a very large amplification that drives the signal into compression. At its output, the signal 145 is applied, which can be fed into the optional block 150 (see FIG. 8) or directly in the adjacent network.

The transimpedance amplifier 350, the amplifier stage 360 and the signals 353 and 145 can also be configured as single wire, i.e., in non-differential topology. If the transimpedance amplifier already has a clamp function, i.e., the same has the option of clipping the signal, it would be possible to omit the block 360, and however, this reduces the sensitivity of the receiver, which is typically not desirable.

The transfer function of the optical-wireless receiver 140 means the output signal 145 (or 353, if block 360 does not exist) divided by the optical input signal 125.

Although these components would be sufficient to realize an optical-wireless receiver, its performance is limited. This would be expressed in low transimpedance amplification or a small photodiode area, which would be equal to a reduced range. Thus, further optional blocks that are to improve the performance of the optical-wireless receiver will be described below. These blocks can be used together or also only partly:
Compensation circuit 320: A compensation circuit can be used to compensate an effective capacitance of the photodiode 311 by quickly recharging the same or by reducing the variation of the voltage across the photodiode capacitance. Different configurations are possible. In the configuration presented herein, e.g., an NPN transistor 321 is connected to the cathode of the photodiode 311 with the base. The emitter of the transistor 321 is connected, e.g., to the anode of the photodiode 311 via the network 322 consisting of a resistor 322a and a capacitance 322b. For example, an impedance (or the second impedance arrangement 323) is used to separate the network 322 and the photodiode 311 from the direct supply voltage 370, such that the compensation circuit can vary the voltage at the node between 323, 322 and 312.
The impedance 323 can be configured as simple resistor 323a. The same can also consist only of a coil 323b or of a series connection of a coil 323b and a resistor 323a. This results in a lower direct current drop across 323, such that more voltage decreases across 322, 321 and 325 (with respect to the reference potential). Thereby, the bias across 311 also remains greater, whereby again its barrier layer capacitance remains lower. Resistor 323a and/or coil 323b are dimensioned, e.g., such that the resulting impedance in the respective frequency range is equal to or greater than the resistor 222a in the network 322 (for example by a factor of at least 1, of at least 5, of at least 10, or of at least 100). For dimensioning the network 322, the following is to be stated: The resistor 322a should be greater than the impedance of the network 322 as discussed above. The capacitance 322b should be significantly greater than the sum of the capacitances of the photodiodes (e.g., by a factor of at least 10, better by a factor of at least 100, even better by a factor of at least 1000).
The following further options result:
A coil 325 between collector of the transistor 321 and the reference potential can be used to generate a peak in the frequency response (of the control circuit consisting of 320 and 310), which is used for low-pass compensation of 140. In that way, the coil 325 can be configured, e.g., to at least partly compensate a low-pass behavior of the amplifier circuit or to realize a maximum in a frequency response of the compensation circuit or a circuit part that includes the compensation circuit and the one or several optical receiving components. The coil 325 can generate the maximum in the transfer function of the block 320 by forming, e.g., an oscillator circuit with the applied capacitances (transistor 321+coil 324).
The coil 325 can be configured such that the maximum in the frequency response of the compensation circuit 320 or of a circuit part that includes the compensation circuit and the one or the several optical receiving components is at a frequency that is greater than the cutoff frequency of the one or several optical receiving components.
The coil 325 can be configured such that the maximum in the frequency response of the compensation circuit 320 or a circuit part that includes the compensation circuit and the one or the several optical receiving components is at a frequency that is less than 120% or 150% or 200% of the cutoff frequency of the one or several optical receiving components.
The cutoff frequency can be defined as described in the context of FIG. 6a and FIG. 6b.
The transistor 321 can be a MOSFET, BJT, JFET or similar transistor. BJT and JFET are advantageous.
If the transistor 321 is an NPN transistor (for the BJT case), the supply voltage 370 has to be negative. If the transistor 321 is a PNP transistor, the supply voltage 370 has to be positive and anode and cathode of the photodiode 311 have to be exchanged so that the same is connected in reverse direction.
The high-pass 330 between the photodiode 310 and the transimpedance amplifier 350 filters, e.g., the direct component from the photocurrent, whereby effectively the portion of the photocurrent that originates from ambient light and the direct component of the signal are attenuated. The high-pass can be configured as simple RC member, but usage of a high-pass of second or higher order (several RC members, LC member, RLC member, active filter) is also possible. Dimensioning the high-pass depends on the frequency spectrum of the communication signal (the signal itself should not be attenuated). The cut-on frequency is typically by the divisor 2, 5, 10 below the lowest usable frequency in the signal.
By using inductive peaking behavior in the form of block 340 between photodiode 311 and transimpedance amplifier 350, the bandwidth of the circuit 140 can be increased further in that this inductance compensates the capacitance applied to this network, i.e., both form, for example, an oscillator circuit. This can be a simple coil but also a more complicated peaking network (T coil peaking network, Pi type peaking, triple resonance peaking, . . . ). The specific inductance value of the coil(s) results from the effective photodiode capacitance C_{PD,eff} and input capacitance of the block 350 Cᵢₙ and can be estimated in first approximation (for example, ±3 . . . 5 dB) with the help of the formula

$$L \approx \frac{1}{{( 2 π f )}^{2} ( {C}_{PD , eff} + {C}_{i n} )} .$$

C_{PD,eff} corresponds to the sum of the photodiode capacitance, the parasitic capacitances and the input capacitance of the compensation circuit 320. The latter results from the sum and the base-collector/base-emitter capacitances. f corresponds to the frequency where the low-pass behavior occurs and is to be compensated.
Thus, the inductive coupling arrangement 340 compensates the applied capacitances by providing an oscillator circuit. This oscillator circuit includes approximately, according to an embodiment: an input capacitance of the amplifier circuit 350 and an input capacitance of the compensation circuit 320 (e.g., transistor capacitances base-collector and base-emitter) and an input capacitance (e.g., capacitance 332) of the high-pass 330 (the capacitance 332 is generally by several orders greater, e.g., 1 nF, 10 nF). 324 carries weight compared to the other two input capacitances or is even greater->by varying 324, the maximum through this oscillator circuit (the peak of 340, so to speak) in the frequency spectrum can be shifted (the greater the capacitance, the less frequency has the maximum). The capacitor 324 is arranged, e.g., at the network between the one or the several optical receiving components 310, the compensation circuit 320 and the inductive coupling arrangement 340 (or at the high-pass 330). The other electrode, for example, would not have to be attached to a collector of the transistor 321 but could be connected to any other (direct voltage) potential.
According to an embodiment, the inductive coupling arrangement is configured to generate a maximum in a frequency response to at least partly compensate a low-pass behavior of the amplifier circuit 350. According to an embodiment, the coupling coil 340 is configured to form a first oscillator circuit together with the capacitor 324 and one or several further capacitances. A resonant frequency of the first oscillator circuit is selected, e.g. to at least partly compensate an effect of a capacitance of the one or the several optical receiving components 310 and/or to at least partly compensate a low-pass behavior of the amplifier circuit 350. According to an embodiment, the inductive coupling arrangement 340 is configured to at least partly compensate a capacitance of the capacitor 332 of the high-pass 330.
The capacitance 324 is used between the base and the collector of the transistor 321 to reduce/adapt its bandwidth to specifically generate a peak in the frequency response of the control circuit consisting of 320 and 310 (the frequency response is the ratio of the current flowing in the direction of block 330 divided by the optical input signal 125). In that way, the low-pass behavior of the optical-wireless receiver circuit 140 can at least be partly compensated. Thus, a low-pass behavior of the amplifier circuit can be at least partly compensated. Dimensioning the capacitance is based on the bandwidth (fₜ) of the transistor 321 and the needed bandwidth of the optical-wireless receiver 140. Typically, this value is in a low one and two digit pF range. For higher frequencies (f>300 MHz), several hundred fF are also possible. The value becomes greater the smaller the needed frequency or at the same frequency, the faster the transistor. The capacitor is configured, e.g., to realize a maximum in a frequency response of the compensation circuit 320 or a circuit part that includes the compensation circuit 320 and the one or the several optical receiving components 310. The capacitance of the capacitor 324 should, for example, not be too great since otherwise the high frequent current flows across the same to ground and does not flow into the base of the transistor 321 (and in that way the voltage across the photodiode cannot be regulated).
The capacitance 324 and/or the coil 325 can be configured such that the maximum in the frequency response of the compensation circuit 420 or a circuit part that includes the compensation circuit and the one or the several optical receiving components is at a frequency that deviates by at most 80% or by at most 40% or by at most 20% from a cutoff frequency of the one or several optical receiving components.
In the feedback path 352 of the transimpedance amplifier, a coil 352c can be connected in series to the resistor 352a or the resistor 352a and the capacitance 352b. As soon as the transfer function of the transimpedance amplifier 350 decreases in the frequency spectrum due to the low-pass behavior, this attenuation can be at least partly compensated by analogously increasing the transimpedance itself. The transimpedance of block 350 is defined by the network/the networks 350_{1,2}. A transimpedance elevation is obtained by the coil 352c since its impedance increases with the frequency and the same is connected in series with the components 352a or 352b. Thus, the coil component 352c is configured, e.g., to at least partly compensate a low-pass behavior of the amplifier circuit 350.
If the transimpedance of block 350 had been reduced by 6 dB, for example, at a specific frequency, the coil 352c should approximately double the impedance in the network 352 at this frequency, i.e., |L|˜|C_{f}∥R| (R . . . 352a, C . . . 352b). C_{f} corresponds to the capacitance between the respective output of 351 to the respective input, i.e., the sum of 352b and parasitic capacitances. From this coarse starting value, the inductance of the coil 352c can be optimized (for example, ±5 dB), for example to shift the elevation slightly into a higher frequency range to increase the bandwidth or to reduce the elevation and possible overshoot. The inductance can also be selected to be lower in order to increase the bandwidth further.

By these methods, the bandwidth is effectively increased and an optical-wireless receiver results that can transmit, for example, a 125 Mbps OOK signal and still has a particularly large active area. Thus, the same is suitable for modern industrial bus standards having data rates of 100 Mbps (125 Mbps baud rate).

A PIN photodiode, an avalanche photodiode or also a silicon photomultiplier can be used as photo detector (or as one or several optical receiving components 310). It is further possible to connect several photodiodes in parallel in order to increase the active area. In that way, the receiving level and hence the link budget can be improved. By the parallel connection, the barrier layer capacitance of the photodiodes sum up, but that can be compensated up to a certain degree by the compensation circuit 320 and the inductive peaking methods.

FIG. 7b and FIG. 7c show alternatives or possible supplements of the receiver circuit 140 in FIG. 7a.

According to an embodiment, the inductive coupling arrangement 340 can comprise a branch circuit path 345. The branch circuit path 345 is coupled between a circuit node that is electrically between the one or the several optical receiving components 310 and the coupling coil 341 and a supply potential or a reference potential 346 on the other hand. The circuit path comprises, e.g., a resistor 342 and/or a capacitor 343. According to the embodiment shown in FIG. 7b or FIG. 7c, the branch circuit path 345 branches between a high-pass 330 and the coupling coil 341.

According to an embodiment, the coupling coil 341 is configured to form a first oscillator circuit together with the capacitor 343 of the branch circuit path and/or together with the one or several further capacitances. The further capacitances can be, e.g., a coupling capacitance and/or a capacitance of the one or several optical receiving components and/or a capacitance of the transistor or the compensation circuit, wherein the coupling capacitance can be connected, e.g., between a terminal of the one or several optical receiving components and the coupling coil. The oscillator circuit counteracts, e.g., a low-pass behavior of the amplifier circuit. Above that, a resonance elevation of the first oscillator circuit and its resonant frequency can be influenced by inserting, e.g., a further capacitance. The same can be, e.g., between the control input of the transistor 321 and a reference potential or directly at the coil 341 as shown in FIG. 7b and FIG. 7c. An optional resistor 342 can be connected in series to this additional capacitor 343 and the reference potential to attenuate the resonance elevation.

According to an embodiment, the further capacitance 343 or the branch circuit path 345 is placed between ground 346 and the coil 341 or ground 346 and the photodiode 311 or ground 364 and the control input of the transistor 321. The coil does not only compensate the already existing capacitances but also this additional capacitor. In that way and by an optional resistor in the path of the additional capacitance, the resonance elevation and the resonant frequency of the oscillator circuit can be effectively adjusted.

Thus, the inductive coupling arrangement 340 compensates the applied capacitances by providing an oscillator circuit. This oscillator circuit includes approximately, according to an embodiment: an input capacitance of the amplifier circuit 350 and an input capacitance of the compensation circuit 320 (e.g., transistor capacitances base-collector and base-emitter) and an input capacitance (e.g., capacitance 332) of the high-pass 330 (the capacitance 332 is normally by several orders greater, e.g., 1 nF, 10 nF).

According to an embodiment, the inductive coupling arrangement 340 is configured to generate a maximum in a frequency response to at least partly compensate a low-pass behavior of the amplifier circuit 350. According to an embodiment, the coupling coil 340 is configured to form a first oscillator circuit together with the capacitor 343 and one or several further capacitances. A resonant frequency of the first oscillator circuit is selected, e.g., to at least partly compensate an effect of a capacitance of the one or the several optical receiving components 310 and/or to at least partly compensate a low-pass behavior of the amplifier circuit 350. According to an embodiment, the inductive coupling arrangement 340 is configured to at least partly compensate a capacitance of the capacitor 332 of the high-pass 330.

Here, it is significant, e.g., how effective a capacitance, such as the capacitor 324 in FIG. 7a or the capacitor 343 in FIG. 7b or FIG. 7c is with respect to the coil 341. This means the capacitance can be at the node between photodiode 311 and base of the transistor and can be connected to ground 346 (this is, for example, also the case in FIG. 7a when the coil 325 does not exist). In the same way, the same can also be arranged directly on the coil 341 as shown in new FIGS. 7b and 7c.

Basically, the circuit functions partly also when the coil 325 exists and the capacitor is connected between base and collector of the transistor, but this leads to the problem that the coil 325 influences the oscillator circuit of the coil 340. If, however, the capacitance 324 is pulled directly to ground from the coil 340 (or the base), coil 325 and coil 340 generate two independent peaks in the overall transfer function that can be shifted essentially independent of one another.

FIG. 7c illustrates a further optional feature of a first impedance arrangement 322 of the compensation circuit 320. In contrary to the first impedance arrangement 322 illustrated in FIG. 7a and FIG. 7b, the capacitor 322b and the resistor 322a are not connected in parallel. Only the capacitor 322b is connected as component or impedance element between a first terminal of a controlled path of the transistor and a second terminal of the one or several optical receiving components. The resistor 322a branches off to a bias 380 or to a reference potential between the capacitor and the first terminal of the controlled path of the transistor.

The capacitance 322b is configured, e.g., to compensate the capacitance of the receiving elements 310. The supply voltage 370 has to be selected to be negative by the NPN transistor 321. This can be problematic when the voltage becomes less than −10V or even −20V (for example, −30V). For generating such negative voltages, the available components are quite expensive. FIG. 7c shows how the problem can be partly prevented:
The receiving elements 310 are operated, e.g., with a positive bias 370, a +30V DC/DC, for example, is easily available; the polarity of the photodiode 311 is reversed accordingly.
The first impedance arrangement 322 capacitively finds the emitter of the transistor 321, for example, via the capacitance 322b with the photodiode 311. The entire direct voltage drop takes place, for example, across this capacitance 322b. The essential voltage drop also takes place, for example, across the photodiode 311. The problem with the first impedance arrangement 323 is now also relaxed and resistor 322a in the kOhm range can be used.
The resistor 322a serves, e.g., to adjust the operating point of the transistor 321. For this, the resistor 322a is connected between the emitter of the transistor 321 and a negative supply voltage 380. As only a series connection of 322a, collector-emitter of 321 (the controlled path of the transistor 321) and optional coil 325 results, as seen from the potential 380, a direct current bias having a small amount of, for example, −5V is sufficient. The potential at the base is defined, e.g., by the high-pass 330 that connects the base to the reference potential via its resistor 331. As the direct component is in the range of μA and a maximum of several mA, the voltage drop across the resistor is normally quite low, such that a respective voltage U_{BE} of the transistor results.

According to an embodiment, the receiver circuit 140 in FIG. 7a can be the first impedance arrangement of FIG. 7c and/or the alternative inductive coupling arrangement 340 of FIG. 7b or FIG. 7c.

FIG. 8 shows a schematic illustration of an optical-wireless communication path comprising an inventive optical-wireless driver circuit 120 and an optical-wireless receiver circuit 140. The optical-wireless driver circuit 120 can comprise features and functionalities as illustrated in FIG. 1, FIG. 5, FIG. 6a and FIG. 6b. The optical-wireless receiver circuit 140 can comprise features and functionalities as illustrated in FIG. 2 to FIG. 4 and FIG. 6a to FIG. 7.

The optical-wireless communication path described herein can use ultraviolet light, visible light and/or infrared light for communication.

The present invention describes circuits for optical-wireless communication allowing bidirectional data transmission in the full duplex mode and hence is compatible with modern industrial bus standards with data rates of up to >100 Mbps (OOK). This solution is characterized by a large link budget, since cost-effective LEDs can be used as transmitters (emitters) and large photodiodes can be used as detector.

Both the optical-wireless driver circuit 120 as well as the optical-wireless receiver circuit 140 (if 360 is no limiting amplifier) allow the usage of other modulation technologies, such as PAM, OFDM or others.

FIG. 8 shows an optical-wireless communication connection for one direction. For a bidirectional full duplex communication, a further communication path is analogously available. The communication path represents, e.g., a real-time transmission path, i.e., the same has a low latency. “Real-time” means that a defined maximum transmission latency may not be exceeded. Depending on the application, this maximum delay can be a maximum of 1 ms, 100 μs, 10 μs but also 1 μs. Apart from the modulation, this is essentially determined by the communication protocol.

The signal 105 represents a data signal of a network, which is fed into the optical-wireless transceiver. First, the signal is processed in the optional block 110. In the real system, this block 110 can be a media converter that converts the wired signal, for example, into an OOK modulated signal. Subsequently, the processed signal 115 is fed into the optical-wireless transmitter 120 of the optical-wireless transceiver. The same drives a current analogously to the processed signal 150. The LED converts the current into an optical signal 125 that is emitted. Optionally, a transmitter optics 130a that forms the optical field of view can be used.

On the other hand, optionally, receiving optics 130b with the aim of optical amplification of the signal. The optical-wireless receiver includes a photodiode with large active area that, at first, converts the optical signal 125 into a photocurrent. Subsequently, the signal is converted into the voltage signal 145 by means of the transimpedance amplifier. To obtain the voltage signal 145, a receiver circuit as described above can be used. The optional block 150 can now be used to process the data further, for example by operating as a media converter. The generated data signal 155 is then again fed into the network.

The decisive factor in the circuits is that the components and methods are matched to each other such that the low-pass behavior of another component is compensated by overshoot or capacitance compensation (boot strapping). Thus, it is possible to also use cost-effective LEDs and generally to extend the link budget. This enables a practical useful usage as wireless real-time communication link.

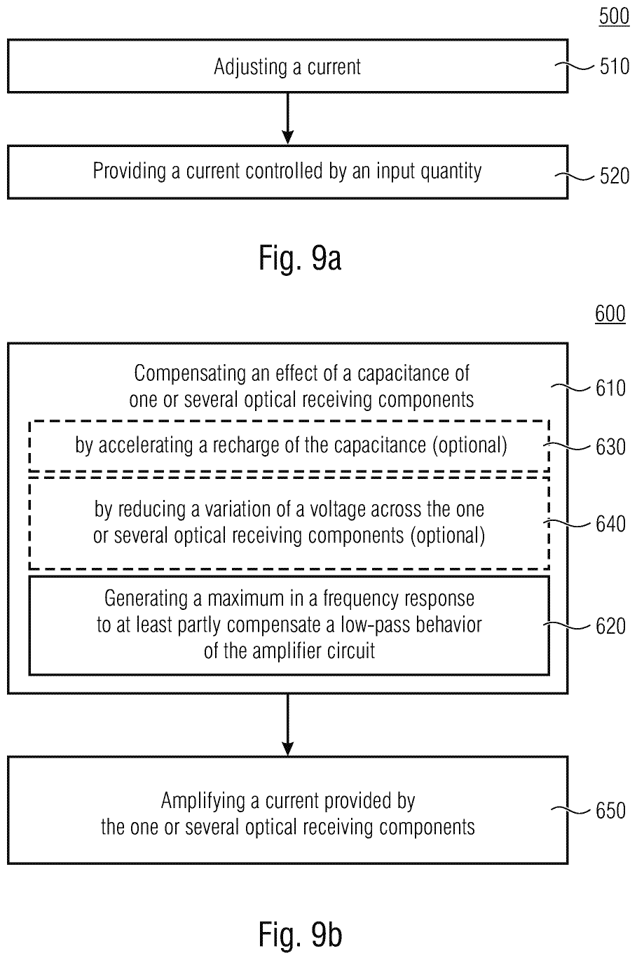

FIG. 9a shows a block diagram of a method 500 for controlling one or several optical transmitting components, such as for a light emitting diode or a parallel connection of light emitting diodes. The method comprises providing 520 a current controlled by an input quantity, wherein a control circuit used when adjusting 510 the current comprises a maximum at a predetermined frequency. Thereby, the method 500 can at least partly compensate a low-pass characteristic of the one or several optical transmitting components or the optoelectronic components in a transfer system.

FIG. 9b shows a block diagram of a method 600 for receiving an optical signal by using one or several optical receiving components for optical-wireless communication. The method comprises at least partly compensating 610 an effect of a capacitance of the one or several optical receiving components. Optionally, compensating 610 is performed by accelerating 630 a recharge of the capacitance or by reducing 640 a variation of a voltage across the one or several optical receiving components. When compensating 610, a maximum is generated 620 in a frequency response to at least partly compensate a low-pass behavior of the amplifier circuit. The frequency response represents, e.g., a ratio between a current provided to the amplifier circuit and an optical input signal to the one or several optical receiving components. The low-pass behavior results typically from the cooperation of the photodiode provided with a capacitance (the one or several optical receiving components) and the transimpedance amplifier (the amplifier circuit). Further, the method 600 comprises amplifying 650 to obtain an amplified output signal based on the current provided by the one or several optical receiving components.

Although some aspects have been described in the context of an apparatus, it is obvious that these aspects also represent a description of the corresponding method, such that a block or device of an apparatus also corresponds to a respective method step or a feature of a method step. Analogously, aspects described in the context of a method step also represent a description of a corresponding block or detail or feature of a corresponding apparatus. Some or all of the method steps may be performed by a hardware apparatus (or using a hardware apparatus), such as a microprocessor, a programmable computer or an electronic circuit. In some embodiments, some or several of the most important method steps may be performed by such an apparatus.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer.

The program code may, for example, be stored on a machine-readable carrier.

Other embodiments comprise the computer program for performing one of the methods described herein, wherein the computer program is stored on a machine readable carrier.

In other words, an embodiment of the inventive method is, therefore, a computer program comprising a program code for performing one of the methods described herein, when the computer program runs on a computer.

A further embodiment of the inventive method is, therefore, a data carrier (or a digital storage medium or a computer-readable medium) comprising, recorded thereon, the computer program for performing one of the methods described herein. The data carrier, the digital storage medium, or the computer-readable medium are typically tangible or non-volatile.

A further embodiment of the inventive method is, therefore, a data stream or a sequence of signals representing the computer program for performing one of the methods described herein. The data stream or the sequence of signals may, for example, be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment in accordance with the invention includes an apparatus or a system configured to transmit a computer program for performing at least one of the methods described herein to a receiver. The transmission may be electronic or optical, for example. The receiver may be a computer, a mobile device, a memory device or a similar device, for example. The apparatus or the system may include a file server for transmitting the computer program to the receiver, for example.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

The apparatuses described herein may be implemented, for example, by using a hardware apparatus or by using a computer or by using a combination of a hardware apparatus and a computer.

The apparatuses described herein or any components of the apparatuses described herein may be implemented at least partly in hardware and/or software (computer program).

The methods described herein may be implemented, for example, by using a hardware apparatus or by using a computer or by using a combination of a hardware apparatus and a computer.

The methods described herein or any components of the methods described herein may be performed at least partly by hardware and/or by software.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] Patent: 2460950 (US2019082521A): DRIVER APPARATUS, PureLiFi, 21 Sep. 2017
[2] Lee, Y.-C. et al., The LED Driver IC of Visible Light Communication with High Data Rate and High Efficiency”, Proc. Of 2016 International Symposium on VLSI Design, Automation and Test (VLSI-DAT)
[3] Patent: 65463371 (WO18138495A1): OPTICAL-WIRELESS COMMUNICATION SYSTEM, PureLiFi
[4] PHILIP C. D. HOBBS, “Photodiode Front Ends”, in Optics & Photonics News, April 2001.
[5] Glen Brisebois, “Low Noise Amplifiers for Small and Large Area Photodiodes”, in Analog Circuit Design/Design Note 399, pp. 905-906, December 2015.

1. Receiver circuit for one or several optical receiving components for optical-wireless communication,
wherein the receiver circuit comprises the one or the several optical receiving components, and
wherein the receiver circuit comprises a compensation circuit that is configured to at least partly compensate an effect of a capacitance of the one optical receiving component or an effect of capacitances of the several optical receiving components, wherein the effect of the capacitance or the capacitances comprises attenuating a photocurrent provided by the one or the several optical receiving components, wherein the compensation circuit is coupled to at least one of the one or several optical receiving components with two terminals,
wherein the receiver circuit comprises an amplifier circuit that is configured to acquire an amplified output signal based on the photocurrent provided by the one or several optical receiving components;
wherein the compensation circuit is configured to generate a maximum in a frequency response to at least partly compensate a low-pass behavior of the amplifier circuit, wherein the frequency response represents a ratio between the photocurrent provided to the amplifier circuit and an optical input signal detected by the one or several optical receiving components;
wherein the compensation circuit comprises a transistor and a first impedance arrangement,
wherein a first terminal of the one or the several optical receiving components is coupled to a control terminal of the transistor,
wherein the first impedance arrangement or at least one component of the first impedance arrangement is connected between a first terminal of a controlled path of the transistor and a second terminal of the one or the several optical receiving components and
wherein a second terminal of the controlled path of the transistor is coupled to a reference potential conductor.

2. Receiver circuit according to claim 1, wherein the compensation circuit comprises a second impedance arrangement to separate the one or several optical receiving components from a supply voltage,
wherein the second impedance arrangement is connected between the second terminal of the one or the several optical receiving components and the supply voltage, and
wherein the second impedance arrangement comprises a coil or a series connection of a resistor and a coil.

3. Receiver circuit according to claim 2, wherein the compensation circuit is configured such that less direct voltage drops across the second impedance arrangement than across the first impedance arrangement and/or across the transistor of the compensation circuit.

4. Receiver circuit according to claim 2, wherein the first impedance arrangement comprises a capacitor and a resistor, wherein the capacitor and the resistor are connected to the first terminal of the controlled path of the transistor, wherein the resistor is further coupled to a bias;
or wherein the first impedance arrangement comprises a parallel connection of the resistor and the capacitor and
wherein the compensation circuit is configured such that the second impedance arrangement comprises an impedance that is equal to or greater than the resistor of the first impedance arrangement.

5. Receiver circuit according to claim 1, wherein the first impedance arrangement comprises a capacitor and a resistor, wherein the capacitor and the resistor are connected to the first terminal of the controlled path of the transistor, wherein the resistor is further coupled to a bias; or
wherein the first impedance arrangement comprises a parallel connection of the resistor and the capacitor and
wherein the compensation circuit is configured such that the capacitor of the first impedance arrangement comprises a capacitance that is greater than the capacitance of the one optical receiving component or than a sum of the capacitances of the one or several optical receiving components.

6. Receiver circuit according to claim 1, wherein the compensation circuit comprises a capacitor that is coupled to the control terminal of the transistor.

7. Receiver circuit according to claim 6, wherein the capacitor is coupled between the control terminal of the transistor and the second terminal of the controlled path of the transistor.

8. Receiver circuit according to claim 6, wherein the capacitor that is coupled to the control terminal of the transistor is configured to at least partly compensate a low-pass behavior of the amplifier circuit.

9. Receiver circuit according to claim 6, wherein the capacitor that is coupled to the control terminal of the transistor is configured to realize the maximum in a frequency response of the compensation circuit or a circuit part that comprises the compensation circuit and the one or the several optical receiving components.

10. Receiver circuit according to claim 1, wherein the compensation circuit comprises a coil that is coupled between the second terminal of the controlled path of the transistor and the reference potential conductor.

11. Receiver circuit according to claim 10, wherein the coil that is coupled between the second terminal of the controlled path of the transistor and the reference potential conductor is configured to at least partly compensate a low-pass behavior of the amplifier circuit.

12. Receiver circuit according to claim 10, wherein the coil that is coupled between the second terminal of the controlled path of the transistor and the reference potential conductor is configured to realize the maximum in a frequency response of the compensation circuit or a circuit part that comprises the compensation circuit and the one or the several optical receiving components.

13. Receiver circuit according to claim 6, wherein the capacitor that is coupled to the control terminal of the transistor and/or the coil that is coupled between the second terminal of the controlled path of the transistor and the reference potential conductor is/are configured such that the maximum in the frequency response of the compensation circuit or a circuit part that comprises the compensation circuit and the one or the several optical receiving components is at a frequency that deviates by at most 80% or by at most 40% or by at most 20% from a cutoff frequency of the one or several optical receiving components.

14. Receiver circuit according to claim 6, wherein the capacitor that is coupled to the control terminal of the transistor and/or the coil that is coupled between the second terminal of the controlled path of the transistor and the reference potential conductor is/are configured such that the maximum in the frequency response of the compensation circuit or a circuit part that comprises the compensation circuit and the one or the several optical receiving components is at a frequency that is greater than the cutoff frequency of the one or several optical receiving components.

15. Receiver circuit according to claim 6, wherein the capacitor that is coupled to the control terminal of the transistor and the reference potential conductor and/or the coil that is coupled between the second terminal of the controlled path of the transistor and the reference potential conductor is/are configured such that the maximum in the frequency response of the compensation circuit or a circuit part that comprises the compensation circuit and the one or the several optical receiving components is at a frequency that is less than 120% or 150% or 200% of the cutoff frequency of the one or several optical receiving components.

16. Receiver circuit according to claim 6, wherein the receiver circuit comprises an inductive coupling arrangement comprising at least one coupling coil that is connected between at least one of the one or several optical receiving components and the amplifier circuit,
wherein the capacitor that is coupled to the control terminal of the transistor is configured to generate a maximum in a frequency response together with the inductive coupling arrangement, to at least partly compensate a low-pass behavior of the amplifier circuit.

17. Receiver circuit according to claim 16, wherein the inductive coupling arrangement comprises a branch circuit path that comprises a capacitor, wherein the branch circuit path is coupled between a circuit node that is electrically between the one or the several optical receiving components and the coupling coil on the one hand and a supply potential or a reference potential on the other hand.

18. Receiver circuit according to claim 16, wherein the coupling coil forms a first oscillator circuit, together with the capacitor that is coupled to the control terminal of the transistor and/or with the capacitor of the branch circuit path; or
wherein the receiver circuit comprises one or several further capacitances and wherein the coupling coil forms the first oscillator circuit together with the capacitor that is coupled to the control terminal of the transistor and/or or with the capacitor of the branch circuit path and/or together with the one or the several further capacitances.

19. Receiver circuit according to claim 18, wherein a resonant frequency of the first oscillator circuit is selected to at least partly compensate the effect of the capacitance of the one optical receiving component or the effect of the capacitances of the several optical receiving components and/or to at least partly compensate the low-pass behavior of the amplifier circuit.

20. Receiver circuit according to claim 18, wherein the first oscillator circuit is configured such that the maximum in the frequency response of the compensation circuit or a circuit part that comprises the compensation circuit and the one or the several optical receiving components is at a frequency that deviates by at most 80% or by at most 40% or by at most 20% from a cutoff frequency of the one or several optical receiving components.

21. Receiver circuit according to claim 18, wherein the first oscillator circuit is configured such that the maximum in the frequency response of the compensation circuit or a circuit part that comprises the compensation circuit and the one or the several optical receiving components is at a frequency that is greater than a cutoff frequency of the one or several optical receiving components.

22. Receiver circuit according to claim 18, wherein the first oscillator circuit is configured such that the maximum in the frequency response of the compensation circuit or a circuit part that comprises the compensation circuit and the one or the several optical receiving components is at a frequency that is less than 100% or 150% or 200% of a cutoff frequency of the one or several optical receiving components.

23. Receiver circuit according to claim 1, wherein a feedback path of the amplifier circuit comprises a series connection of a coil component and an impedance arrangement and
wherein the impedance arrangement comprises at least one capacitor and/or a resistor,
wherein the coil component is configured to at least partly compensate a low-pass behavior of the amplifier circuit.

24. Receiver circuit for one or several optical receiving components for optical-wireless communication,
wherein the receiver circuit comprises the one or the several optical receiving components, and
wherein the receiver circuit comprises an amplifier circuit that is configured to acquire an amplified output signal based on a current provided by the one or several optical receiving components;
wherein the amplifier circuit comprises an operational amplifier;
wherein a feedback path of the amplifier circuit comprises a series connection of a coil component and an impedance arrangement,
wherein the impedance arrangement comprises at least one capacitor and/or one resistor; and
wherein the coil component is configured to at least partly compensate a low-pass behavior of the amplifier circuit.

25. Receiver circuit according to claim 24, wherein the coil component is configured to increase a transimpedance of the amplifier circuit with increasing frequency.

26. Receiver circuit according to claim 24, wherein the impedance arrangement comprises a parallel connection of a resistor and a capacitor.

27. Receiver circuit according to claim 25, wherein the operational amplifier is configured in a differential manner,
wherein the feedback path runs from a first output to a first input,
wherein a second feedback path runs from a second output to a second input,
wherein the second feedback path comprises a further series connection of a coil component and an impedance arrangement.

28. Method for receiving an optical signal by using one or several optical receiving components for optical-wireless communication,
wherein the method comprises at least partly compensating an effect of a capacitance of the one optical receiving components or an effect of capacitances of the several optical receiving components, wherein the effect of the capacitance or the capacitances comprises attenuating a photocurrent provided by the one or the several optical receiving components,
wherein the method comprises amplifying to acquire an amplified output signal based on the photocurrent provided by the one or several optical receiving components;
wherein, during compensating, a maximum is generated in a frequency response to at least partly compensate a low-pass behavior of the amplifier circuit, wherein the frequency response represents a ratio between the photocurrent provided to the amplifier circuit and an optical input signal detected by the one or several optical receiving components;
wherein compensating is performed by means of a transistor and a first impedance arrangement,
wherein a first terminal of the one or the several optical receiving components is coupled to a control terminal of the transistor,
wherein the first impedance arrangement or at least one component of the first impedance arrangement is connected between a first terminal of a controlled path of the transistor and a second terminal of the one or the several optical receiving components and
wherein a second terminal of the controlled path of the transistor is coupled to a reference potential conductor.
